(19) United States
(12) Patent Application Publication
(10) Pub. No.: US 2026/0109021 A1
(43) Pub. Date: Apr. 23, 2026

(54) ROBOT

(71) Applicant: Suzhou Xinghaitu Dynamics Technology Co., Ltd., Suzhou (CN)

(72) Inventors: Yao WU, Suzhou (CN); Xinqiao CHEN, Suzhou (CN); Zeyi YANG, Suzhou (CN)

(21) Appl. No.: 19/365,343

(22) Filed: Oct. 22, 2025

(30) Foreign Application Priority Data
Oct. 23, 2024 (CN) 202422565391.3

(51) Int. Cl. B25J 9/00

(52) U.S. Cl. CPC B25J 9/0003; B25J 9/0009

(57) ABSTRACT

A robot includes a torso structure, a head structure, robotic arms, gripper structures, and a chassis driving structure. The torso structure includes a lower leg assembly, a thigh assembly, and a thoracic cavity assembly. A first torso motor, a second torso motor, and a third torso motor enable a multi-joint rotation within a plane formed by a first direction and a second direction. A fourth torso motor drives the thoracic cavity assembly to rotate relative to the thigh assembly around an output shaft of the fourth torso motor within a plane formed by the second direction and a third direction. Two opposite sides of the end of the thoracic cavity assembly facing away from the thigh assembly are provided with the robotic arms respectively, and the gripper structures are securely mounted at tail ends of the robotic arms respectively.

### CROSS-REFERENCE TO RELATED APPLICATION(S)

This application claims priority to Chinese Patent Application No. 202422565391.3 filed Oct. 23, 2024, the disclosure of which is incorporated herein by reference in its entirety.

### TECHNICAL FIELD

The present disclosure relates to the technical field of robot devices, and in particular, to a robot.

### BACKGROUND

With the advancement of computer technology, microelectronic technology, and network technology, robotic technology has also developed rapidly. At present, robots are applied not only in the industrial field but also in fields closely related to daily life, such as service robots, educational robots, and entertainment robots. These robots are provided with structures such as heads, torsos, and bases, and the production and application of these robots have brought convenience and enjoyment to human life. A torso structure of a robot serves as the main support portion of the overall structure. However, the overall structure of the torso structure in the related art has limited swingable directions and angles, resulting in poor flexibility. Moreover, a torso portion is relatively heavy, which reduces the overall motion stability of the robot.

### SUMMARY

The present disclosure provides a robot to solve at least one of the problems in the preceding related art.

According to embodiments of the present disclosure, a robot is provided. The robot includes a torso structure, a head structure, robotic arms, gripper structures, and a chassis driving structure.

The torso structure includes a lower leg assembly, a thigh assembly, and a thoracic cavity assembly, where the lower leg assembly includes a first torso motor, the lower leg assembly is rotatably connected to a robotic chassis structure through the first torso motor, and when the first torso motor operates, the first torso motor is configured to drive the lower leg assembly to rotate relative to the robotic chassis structure around an output shaft of the first torso motor within a plane formed by a first direction and a second direction; the thigh assembly includes a second torso motor, the thigh assembly is rotatably connected to the lower leg assembly through the second torso motor, and when the second torso motor operates, the second torso motor is configured to drive the thigh assembly to rotate relative to the lower leg assembly around an output shaft of the second torso motor within the plane formed by the first direction and the second direction; the thoracic cavity assembly includes a third torso motor, a third torso motor seat, a fourth torso motor, and a fourth torso motor seat, the third torso motor is disposed within the third torso motor seat, and an output shaft of the third torso motor is rotatably connected to the thigh assembly; the fourth torso motor seat is securely connected to an outer surface of the third torso motor seat, the fourth torso motor is disposed on the fourth torso motor seat, and an output shaft of the fourth torso motor is rotatably connected to the fourth torso motor seat; the thoracic cavity assembly is rotatably connected to the thigh assembly through the third torso motor and the fourth torso motor; when the third torso motor operates, the third torso motor is configured to drive the thoracic cavity assembly to rotate relative to the thigh assembly around the output shaft of the third torso motor within the plane formed by the first direction and the second direction; when the fourth torso motor operates, the fourth torso motor is configured to drive the thoracic cavity assembly to rotate relative to the thigh assembly around the output shaft of the fourth torso motor within a plane formed by the second direction and a third direction; the head structure is disposed at a middle portion of one end of the thoracic cavity assembly facing away from the thigh assembly; two opposite sides of the end of the thoracic cavity assembly facing away from the thigh assembly are provided with the robotic arms respectively, and the gripper structures are securely mounted at tail ends of the robotic arms respectively; and one end of the lower leg assembly facing away from the thigh assembly is securely connected to the chassis driving structure.

The first direction is a direction configured to be perpendicular to a ground, and the first direction, the second direction, and the third direction are perpendicular to one another.

The embodiments of the present disclosure have the following beneficial effects. The torso structure of the robot has multiple degrees of freedom and can flexibly control the motions of the joints to perform various actions. Moreover, the torso structure of the robot is relatively lightweight and cost-effective. In addition, the torso structure of the robot adopts internal wiring within the housing, which makes the overall structure more aesthetically pleasing. The head structure features a compact overall design and is easy to disassemble, facilitating maintenance and inspection during testing and thereby significantly improving maintenance efficiency. Through the arrangement of multiple joint mechanisms together with an upper arm and a forearm, a robotic arm can rotate in multiple degrees of freedom, and a tail end of the robotic arm can be lighter, thereby increasing the payload at the tail end. A gripper structure converts the rotary motion of a motor into the linear motion, which makes the gripper structure have a high torque with a minimized volume and have high reliability. In addition, the chassis structure of the entire robot forms a compact configuration similar to a triangle. A chassis upper housing is mounted onto a chassis middle housing, and the chassis middle housing, a chassis middle front housing, a chassis middle rear housing, and a chassis lower housing are all mounted onto a chassis skeleton assembly. Therefore, during testing, maintenance and inspection can be performed simply by accessing the internal structure by removing the chassis upper housing from the chassis middle housing and detaching the chassis middle housing, the chassis middle front housing, and the chassis middle rear housing from the chassis skeleton assembly. The chassis structure has an overall compact design with convenient disassembly, thereby facilitating the maintenance and inspection during testing and significantly improving the maintenance efficiency.

### BRIEF DESCRIPTION OF DRAWINGS

To illustrate technical solutions in the embodiments of the present disclosure or the related art more clearly, drawings used in the description of the embodiments or the related art are briefly described below. Apparently, the drawings described below illustrate only part of the embodiments of the present disclosure, and those of ordinary skill in the art may obtain other drawings based on the drawings described below on the premise that no creative work is done.

FIG. 1 is a structural view of a torso structure according to an embodiment of the present disclosure.

FIG. 2 is a structural view of a torso structure without a torso housing according to an embodiment of the present disclosure.

FIG. 3 is a structural view of a lower leg assembly in a torso structure according to an embodiment of the present disclosure.

FIG. 4 is a structural view of a lower leg output connecting rod in a torso structure according to an embodiment of the present disclosure, where (a) is an axonometric view from the inner side of the lower leg output connecting rod, and (b) is an axonometric view from the outer side of the lower leg output connecting rod.

FIG. 5 is a structural view of a lower leg auxiliary connecting rod in a torso structure according to an embodiment of the present disclosure, where (a) is an axonometric view from the outer side of the lower leg auxiliary connecting rod, and (b) is an axonometric view from the inner side of the lower leg auxiliary connecting rod.

FIG. 6 is a structural view of a lower leg connecting support rod in a torso structure according to an embodiment of the present disclosure.

FIG. 7 is a structural view of a second torso motor seat in a torso structure according to an embodiment of the present disclosure.

FIG. 8 is a structural view of a thigh assembly in a torso structure according to an embodiment of the present disclosure.

FIG. 9 is a structural view of a thigh output connecting rod in a torso structure according to an embodiment of the present disclosure, where (a) is an axonometric view from the inner side of the thigh output connecting rod, and (b) is an axonometric view from the outer side of the thigh output connecting rod.

FIG. 10 is a structural view of a thigh auxiliary connecting rod in a torso structure according to an embodiment of the present disclosure, where (a) is an axonometric view from the outer side of the thigh auxiliary connecting rod, and (b) is an axonometric view from the inner side of the thigh auxiliary connecting rod.

FIG. 11 is an axonometric view from the rear side of a thoracic cavity bracket in a torso structure according to an embodiment of the present disclosure.

FIG. 12 is an axonometric view from the front side of a thoracic cavity bracket in a torso structure according to an embodiment of the present disclosure.

FIG. 13 is a structural view of a thoracic cavity bracket in a torso structure according to an embodiment of the present disclosure, where mounting seats and mounting frames are mounted.

FIG. 14 is a structural view of a thoracic cavity bracket in a torso structure according to an embodiment of the present disclosure, where mounting seats, mounting frames, and elements are mounted.

FIG. 15 is a structural view of a thoracic cavity assembly in a torso structure according to an embodiment of the present disclosure.

FIG. 16 is an axonometric view from the rear side of a thoracic cavity housing in a torso structure according to an embodiment of the present disclosure.

FIG. 17 is a view of the assembly of a front shoulder housing in a torso structure according to an embodiment of the present disclosure.

FIG. 18 is a view of the assembly of a front chest housing in a torso structure according to an embodiment of the present disclosure.

FIG. 19 is a view of the assembly of front and rear bottom housings in a torso structure according to an embodiment of the present disclosure.

FIG. 20 is a structural view of front and rear bottom housings in a torso structure according to an embodiment of the present disclosure.

FIG. 21 is a structural view of a rear chest housing and front and rear bottom housings in a torso structure according to an embodiment of the present disclosure.

FIG. 22 is a structural view of a head structure according to an embodiment of the present disclosure.

FIG. 23 is an exploded view of a head structure according to an embodiment of the present disclosure.

FIG. 24 is a structural view of a head front housing and a head skeleton assembly in a head structure according to an embodiment of the present disclosure.

FIG. 25 is a structural view of a head middle housing and connecting plates in a head structure according to an embodiment of the present disclosure.

FIG. 26 is a structural view of a robotic arm according to an embodiment of the present disclosure.

FIG. 27 is a view of the assembly of a robotic arm base, a first joint mechanism, and a second joint mechanism in a robotic arm according to an embodiment of the present disclosure.

FIG. 28 is a partial structural view of a first joint mechanism in a robotic arm according to an embodiment of the present disclosure.

FIG. 29 is a cross-sectional view of a first joint mechanism in a robotic arm according to an embodiment of the present disclosure.

FIG. 30 is a partial view of the assembly of a first joint output member in a robotic arm according to an embodiment of the present disclosure.

FIG. 31 is a structural view of a first joint mechanism, a second joint mechanism, and a robotic upper arm structure in a robotic arm according to an embodiment of the present disclosure.

FIG. 32 is a view of the assembly of an upper arm lower housing in a robotic arm according to an embodiment of the present disclosure.

FIG. 33 is a view of the assembly of a second joint mechanism, an upper arm upper frame, and an upper arm lower frame in a robotic arm according to an embodiment of the present disclosure.

FIG. 34 is a view of the assembly of an upper arm upper frame, an upper arm lower frame, and a third joint mechanism in a robotic arm according to an embodiment of the present disclosure.

FIG. 35 is a view of the assembly of a third joint mechanism, a fourth joint mechanism, a robotic forearm structure, a fifth joint mechanism, and a sixth joint mechanism in a robotic arm according to an embodiment of the present disclosure.

FIG. 36 is a structural view of a third joint mechanism, a fourth joint mechanism, a robotic forearm structure, a fifth joint mechanism, and a sixth joint mechanism in a robotic arm according to an embodiment of the present disclosure, where motors, bearings, a forearm upper housing, and a forearm snap-fit housing are not mounted.

FIG. 37 is a structural view of a first joint auxiliary portion in a robotic arm according to an embodiment of the present disclosure.

FIG. 38 is a partial structural view of a fourth joint mechanism in a robotic arm according to an embodiment of the present disclosure.

FIG. 39 is a structural view of a fourth arm motor and a fourth arm bearing seat in a robotic arm according to an embodiment of the present disclosure.

FIG. 40 is a view of the assembly of connecting rods of a robotic forearm structure in a robotic arm according to an embodiment of the present disclosure.

FIG. 41 is a view of the assembly of a forearm lower housing and a forearm snap-fit housing in a robotic arm according to an embodiment of the present disclosure.

FIG. 42 is a structural view of a forearm snap-fit housing in a robotic arm according to an embodiment of the present disclosure.

FIG. 43 is a structural view of a forearm upper housing in a robotic arm according to an embodiment of the present disclosure.

FIG. 44 is a partial view of the assembly of a sixth joint mechanism and a fifth joint mechanism in a robotic arm according to an embodiment of the present disclosure.

FIG. 45 is a structural view of a gripper structure from a first angle of view according to an embodiment of the present disclosure.

FIG. 46 is a structural view of a gripper structure from a second angle of view according to an embodiment of the present disclosure.

FIG. 47 is an exploded view of a gripper structure according to an embodiment of the present disclosure.

FIG. 48 is a view of the assembly of a grooved wheel in a gripper structure according to an embodiment of the present disclosure.

FIG. 49 is a first partial structural view of a rotary-to-linear mechanism in a gripper structure according to an embodiment of the present disclosure.

FIG. 50 is a second partial structural view of a rotary-to-linear mechanism in a gripper structure according to an embodiment of the present disclosure.

FIG. 51 is a structural view of a chassis driving structure according to an embodiment of the present disclosure.

FIG. 52 is an exploded view of a chassis driving structure according to an embodiment of the present disclosure.

FIG. 53 is a structural view of a chassis skeleton assembly of a chassis driving structure from one angle according to an embodiment of the present disclosure.

FIG. 54 is a structural view of a chassis skeleton assembly of a chassis driving structure from another angle according to an embodiment of the present disclosure.

FIG. 55 is a structural view of a robot according to an embodiment of the present disclosure.

### DETAILED DESCRIPTION

The technical solutions in the embodiments of the present disclosure are described clearly and completely in conjunction with the drawings in the embodiments of the present disclosure. Apparently, the embodiments described hereinafter are part, not all, of embodiments of the present disclosure. Based on the embodiments of the present disclosure, all other embodiments obtained by those of ordinary skill in the art are within the scope of the present disclosure on the premise that no creative work is done.

It is to be noted that terms “including”, “having”, and any other variations in the embodiments of the present disclosure and the drawings are intended to encompass a non-exclusive inclusion. For example, a component includes a series of structures, but is not limited to the structures listed. Optionally, the component may further include structures not listed or other parts inherent to these structures.

The embodiments of the present disclosure provide a robot. Detailed descriptions are provided below.

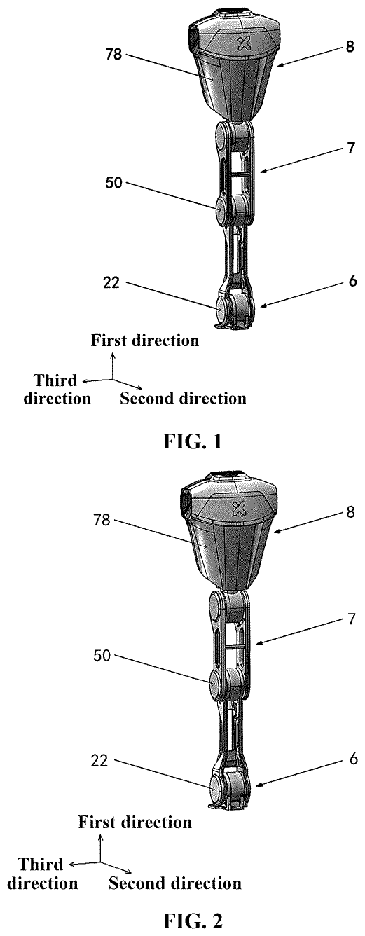

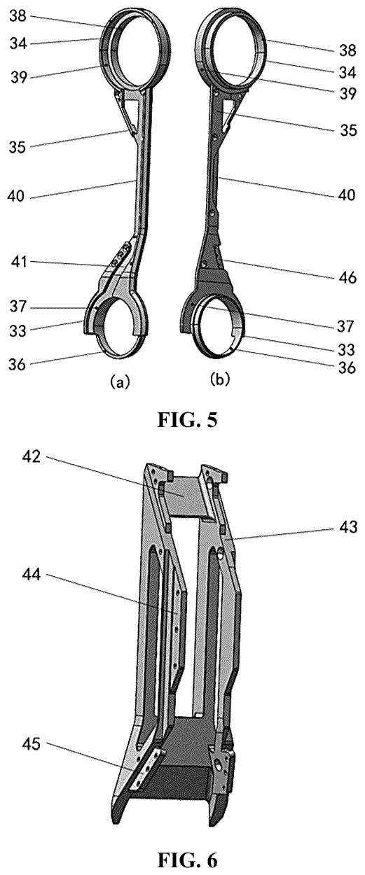

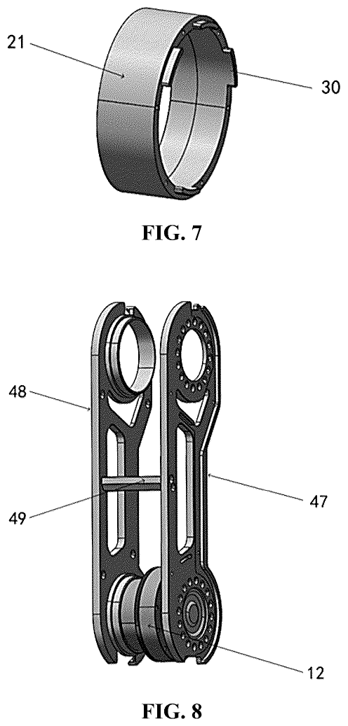

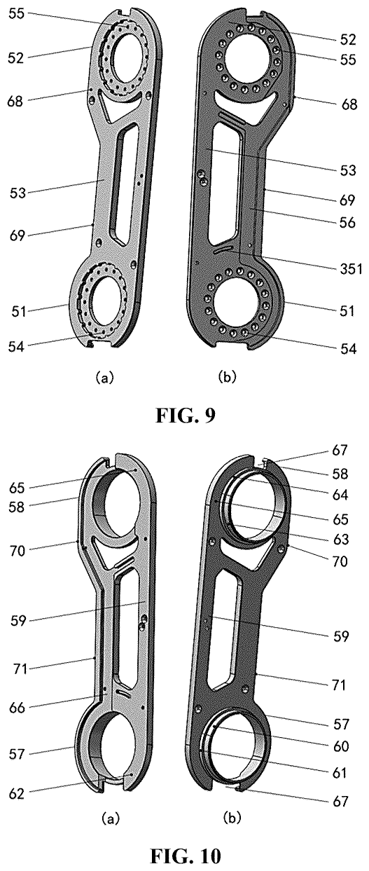

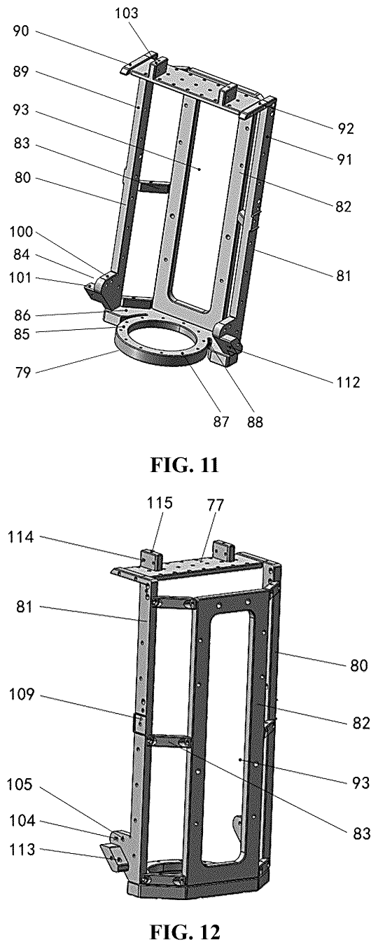

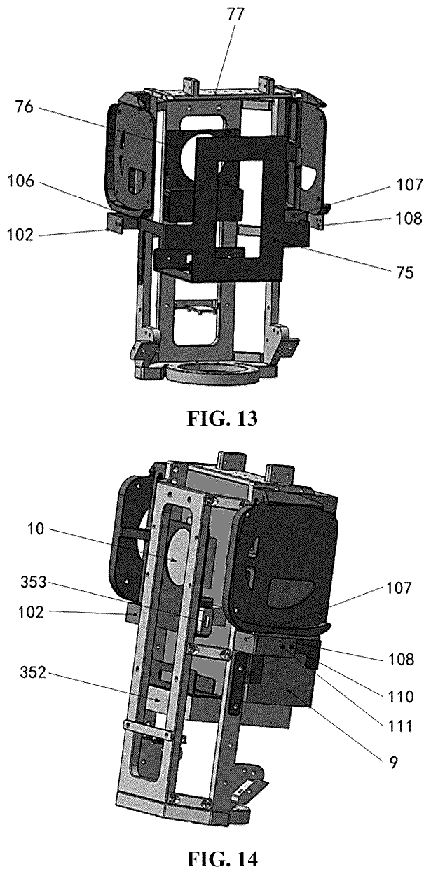

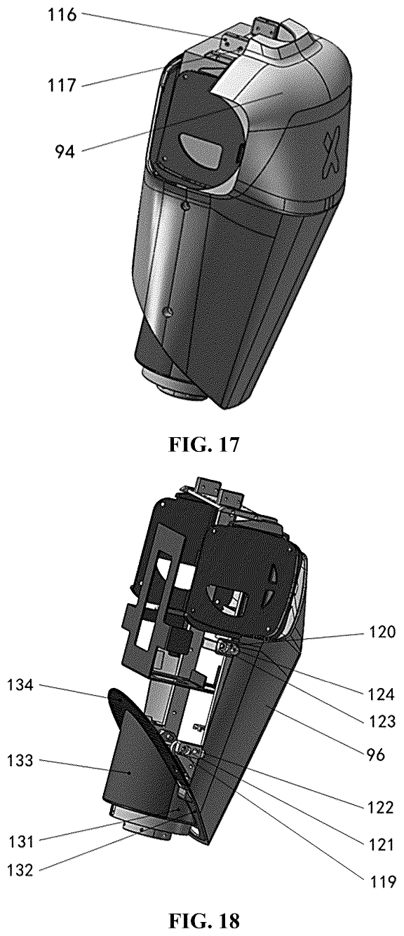

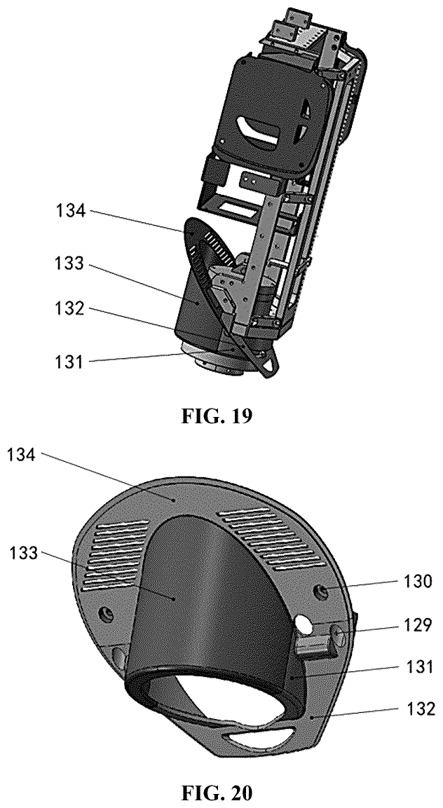

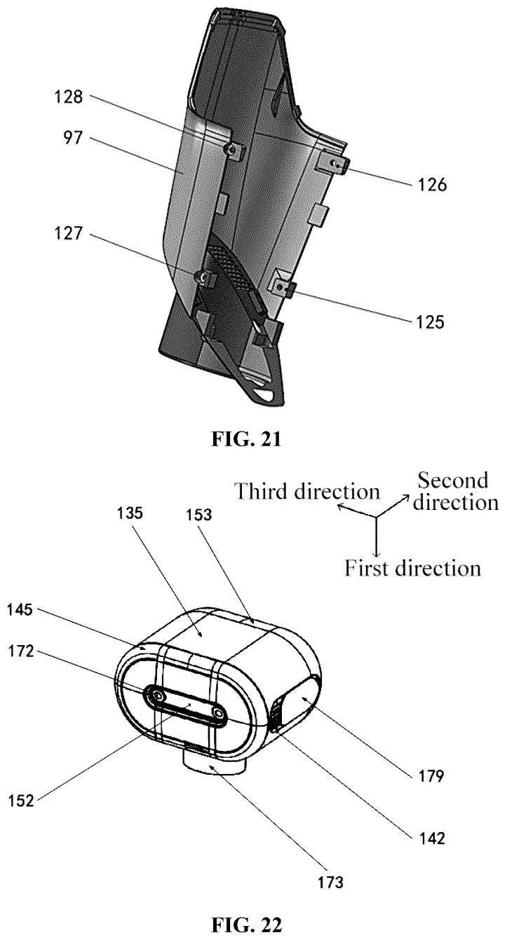

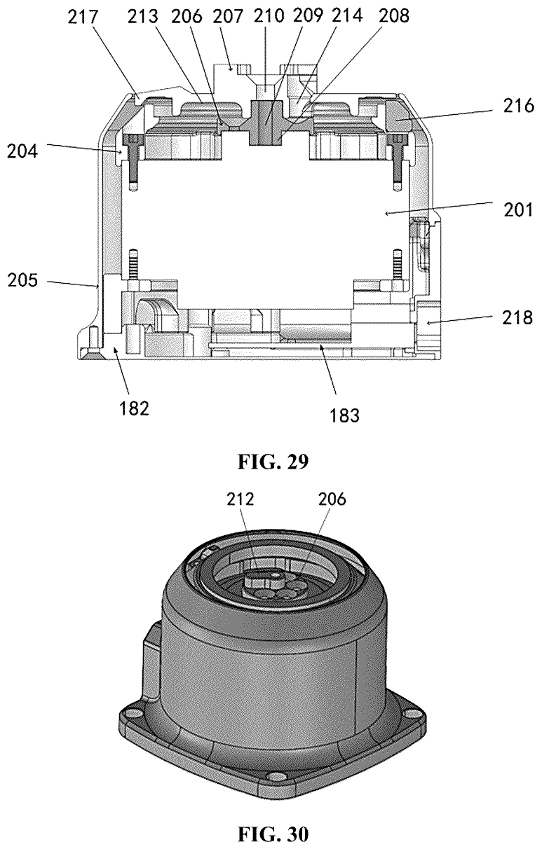

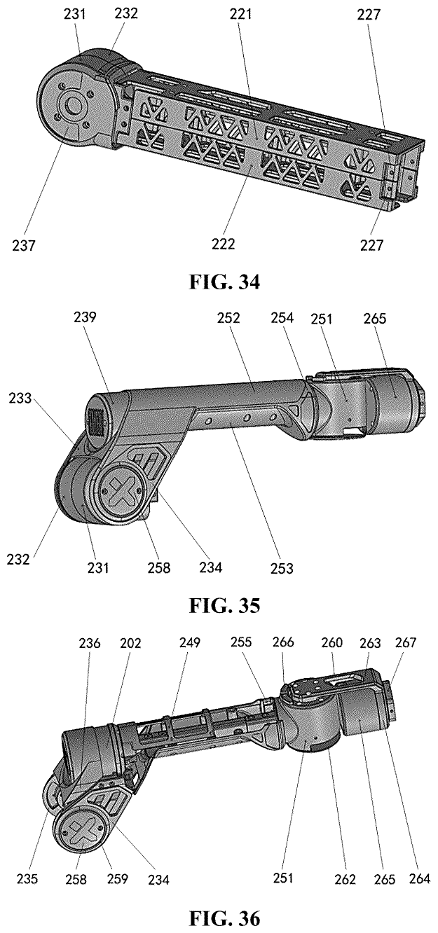

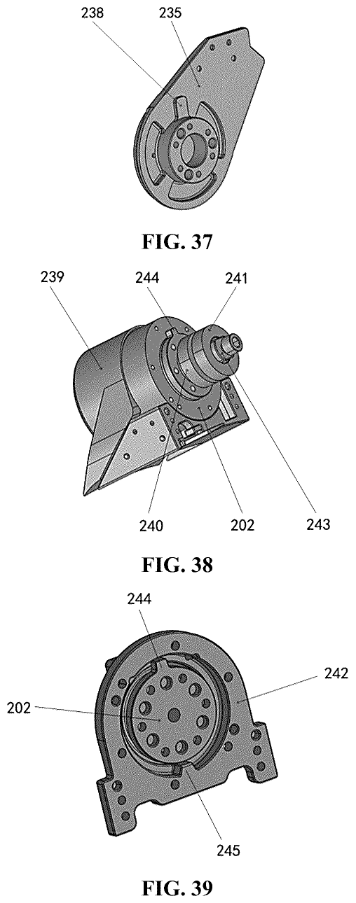

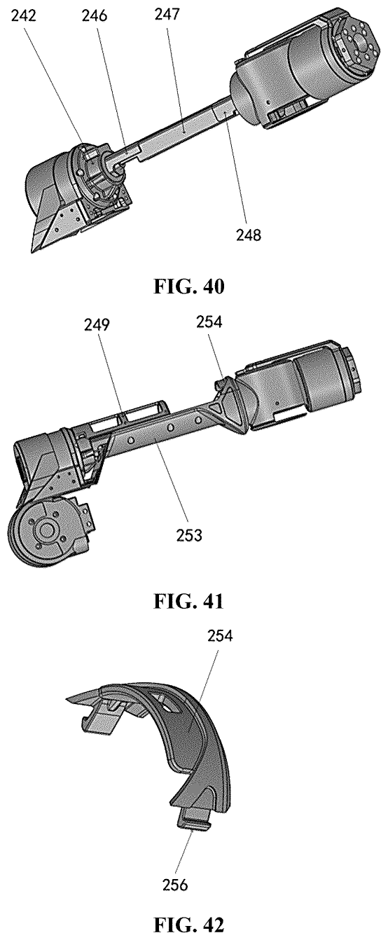

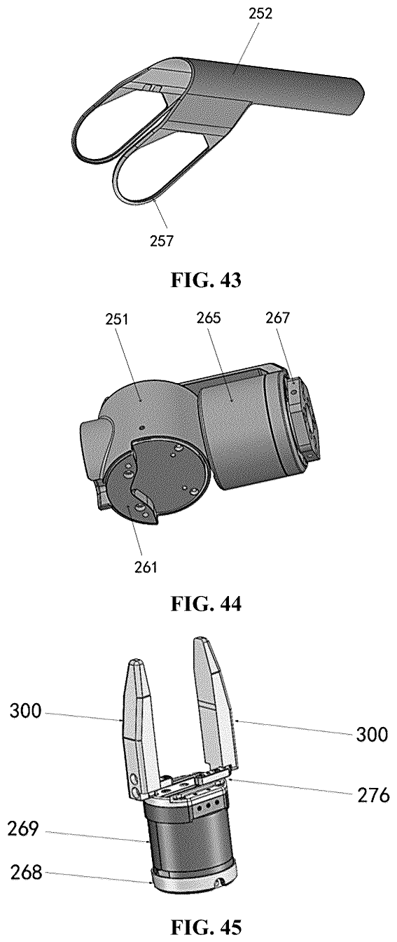

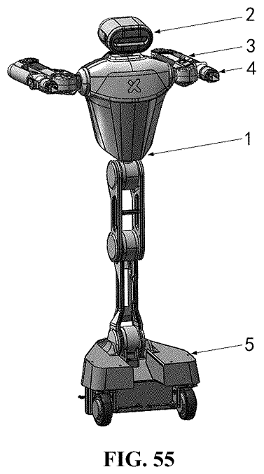

FIGS. 1 to 55 illustrate a robot according to the embodiments of the present disclosure. As shown in FIGS. 1 to 55, the robot includes a torso structure 1, a head structure 2, robotic arms 3, gripper structures 4, and a chassis driving structure 5. The head structure 2 is disposed at a middle portion of one end of a thoracic cavity assembly of the torso structure 1 facing away from a thigh assembly of the torso structure 1. Two opposite sides of the end of the thoracic cavity assembly of the torso structure 1 facing away from the thigh assembly of the torso structure 1 are provided with the robotic arms 3 respectively. The gripper structures 4 are securely mounted at tail ends of the robotic arms 3 respectively. One end of a lower leg assembly of the torso structure 1 facing away from the thigh assembly of the torso structure 1 is securely connected to the chassis driving structure 5. The torso structure 1 includes the lower leg assembly 6, the thigh assembly 7, and the thoracic cavity assembly 8. The lower leg assembly 6 is connected to the chassis driving structure 5 and is further connected to the thoracic cavity assembly 8 through the thigh assembly 7. The head structure 2, left and right robotic arms 3, and various robotic elements (such as a personal computer (PC) host 9 and a robotic controller 10) are all disposed on the thoracic cavity assembly 8. The thoracic cavity assembly 8 is configured for the connection of the remaining components of the robot. The lower leg assembly 6 and the thigh assembly 7 enable the thoracic cavity assembly 8 of the robot to move in multiple degrees of freedom. Specifically, the lower leg assembly 6 includes a first torso motor 11, and the lower leg assembly 6 is rotatably connected to the chassis driving structure 5 through the first torso motor 11; the thigh assembly 7 includes a second torso motor 12, and the thigh assembly 7 is rotatably connected to the lower leg assembly 6 through the second torso motor 12; the thoracic cavity assembly 8 includes a third torso motor 13, a third torso motor seat 14, a fourth torso motor 15, and a fourth torso motor seat 16. The third torso motor 13 is disposed within the third torso motor seat 14, and an output shaft of the third torso motor 13 is rotatably connected to the thigh assembly 7; the fourth torso motor seat 16 is securely connected to an outer surface of the third torso motor seat 14, the fourth torso motor 15 is disposed on the fourth torso motor seat 16, and an output shaft of the fourth torso motor 15 is rotatably connected to the fourth torso motor seat 16; the thoracic cavity assembly 8 is rotatably connected to the thigh assembly 7 through the third torso motor 13 and the fourth torso motor 15. When the first torso motor 11 operates, the first torso motor 11 drives the lower leg assembly 6 to rotate relative to the chassis driving structure 5 of the robot around an output shaft of the first torso motor 11 within a plane formed by a first direction and a second direction. When the second torso motor 12 operates, within the plane formed by the first direction and the second direction, the second torso motor 12 drives the thigh assembly 7 to rotate relative to the lower leg assembly 6 around an output shaft of the second torso motor 12. When the third torso motor 13 operates, the third torso motor 13 drives the thoracic cavity assembly 8 to rotate relative to the thigh assembly 7 around the output shaft of the third torso motor 13 within the plane formed by the first direction and the second direction. When the fourth torso motor 15 operates, the fourth torso motor 15 drives the thoracic cavity assembly 8 to rotate relative to the thigh assembly 7 around the output shaft of the fourth torso motor 15 within a plane formed by the second direction and a third direction. As such, the torso structure 1 enables multi-portion rotation within the plane formed by the first direction and the second direction through the first torso motor 11, the second torso motor 12, and the third torso motor 13 so that the robot can move more flexibly. In addition, the fourth torso motor 15 enables the thoracic cavity assembly 8 to rotate within the plane formed by the second direction and the third direction so that the robot can obtain a wider field of view.

In the present disclosure, the first direction is a direction perpendicular to the ground, the second direction is a viewing direction of the head structure 2, and the second direction, the first direction, and the third direction are perpendicular to one another. It is to be noted that the term “perpendicular” in the present disclosure is not to be construed as strictly perpendicular, but may encompass a range of 90°±10°. Similarly, the term “parallel” in the present disclosure is not to be construed as strictly parallel, but may encompass a range of 180°±10°.

In some embodiments, as shown in FIGS. 1 to 3, the lower leg assembly 6 further includes a first torso motor seat 17, a first torso bearing a lower leg output connecting rod 18, a lower leg auxiliary connecting rod 19, a lower leg connecting support rod 20, a second torso motor seat 21, and lower leg housings 22. Specifically, one end of the first torso motor seat 17 facing the chassis driving structure 5 of the robot is provided with multiple mounting lugs 23, each mounting lug 23 extends along a direction facing away from the first torso motor seat 17 within the plane formed by the second direction and the third direction, and each mounting lug 23 is provided with multiple bolt mounting holes. As such, the first torso motor seat 17 is securely connected to the chassis driving structure 5 of the robot through the multiple mounting lugs 23 using bolts. In a specific implementation, three edges or two opposite edges of the first torso motor seat 17 may be each provided with a mounting lug 23, so as not to interfere with a kneeling action of the robot while ensuring the overall stability of the secure mounting of the torso structure 1. The first torso motor 11 is mounted onto the first torso motor seat 17, the output shaft of the first torso motor 11 extends along the third direction, and both the output shaft of the first torso motor 11 and a motor tail cover of the first torso motor 11 penetrate through the first torso motor seat 17 to the outside of the first torso motor seat 17. Moreover, a first torso bearing seat 24 is securely disposed at a motor tail cover of the first torso motor seat 17, and the first torso bearing is disposed on the first torso motor seat 17 through the first torso bearing seat 24 and is located at one end of the motor tail cover of the first torso motor 11. A first end of the lower leg output connecting rod 18 is securely connected to the output shaft of the first torso motor 11, a first end of the lower leg auxiliary connecting rod 19 is rotatably connected to the first torso motor seat 17 through the first torso bearing, and a second end of the lower leg output connecting rod 18 and a second end of the lower leg auxiliary connecting rod 19 are securely connected to two ends of the second torso motor seat 21 respectively. As such, the first torso motor 11 drives the lower leg output connecting rod 18 to rotate to enable a lower leg portion of the robot to perform a bending action. The lower leg auxiliary connecting rod 19 assists the rotation of the lower leg output connecting rod 18, and two ends of the lower leg connecting support rod 20 along the third direction are securely connected to the lower leg output connecting rod 18 and the lower leg auxiliary connecting rod 19 respectively such that the lower leg connecting support rod 20, the lower leg auxiliary connecting rod 19, and the lower leg output connecting rod 18 are connected. This further ensures the support strength and rotary stability of the lower leg portion and also reduces the overall cost of the robot. Further, in the specific implementation, the material of the lower leg connecting support rod 20, the material of the lower leg auxiliary connecting rod 19, and the material of the lower leg output connecting rod 18 may be specifically selected as needed, and the same material or different materials may be used. An outer surface of the lower leg output connecting rod 18 and an outer surface of the lower leg auxiliary connecting rod 19 are provided with the lower leg housings 22 respectively to make the lower leg portion of the robot more aesthetically pleasing.

In a specific embodiment, as shown in FIGS. 2 to 4 and 7, the lower leg output connecting rod 18 includes a first lower leg output portion 25, a second lower leg output portion 26, and a lower leg output connecting portion 27. The first lower leg output portion 25 is an annular plate structure, and multiple first output mounting holes 28 are evenly and equidistantly spaced apart along a circumferential direction of the first lower leg output portion 25. The lower leg output connecting rod 18 is securely connected to the output shaft of the first torso motor 11 through the multiple first output mounting holes 28 using bolts. The second lower leg output portion 26 is a circular cylindrical structure, with the shape size adapted to the shape size of the second torso motor seat 21. A circular end surface of the second lower leg output portion 26 facing the second torso motor seat 21 is formed with at least one output positioning groove 29. Correspondingly, a circular end surface of the second torso motor seat 21 facing the second lower leg output portion 26 is provided with at least one output positioning block 30. Each output positioning block 30 corresponds to a respective output positioning groove 29. During the lower leg output connecting rod 18 and the second torso motor seat 21 are assembled, each output positioning block 30 is snap-fitted into the respective output positioning groove 29, thereby enabling a positioning connection between the lower leg output connecting rod 18 and the second torso motor seat 21. Subsequently, the second lower leg output portion 26 is securely connected to the second torso motor seat 21 by bolts. In the specific implementation, one half-circular end surface of the second lower leg output portion 26 may be formed with three output positioning grooves 29, where the distance between every two output positioning grooves 29 is equal, and a middle portion of the other half-circular end surface of the second lower leg output portion 26 may be formed with one output positioning groove 29, thereby avoiding misassembly. In addition, two ends of the lower leg output connecting portion 27 along the first direction are integrally connected to the first lower leg output portion 25 and the second lower leg output portion 26 respectively. Moreover, a middle portion of the lower leg output connecting portion 27 along the first direction is provided with an output notch 31, so as to provide a mounting position for the lower leg auxiliary connecting rod 19, thereby enabling a larger contact and securing connection surface between the lower leg output connecting portion 27 and the lower leg auxiliary connecting rod 19. Further, a side surface of the lower leg output connecting portion 27 facing away from the lower leg auxiliary connecting rod 19 in the third direction is formed with a lower leg output wire groove 32, and the lower leg output wire groove 32 extends from one end of the first lower leg output portion 25 to one end of the second lower leg output portion 26. A lower leg housing 22 is disposed on the outer surface of the lower leg output connecting rod 18, that is, the lower leg output wire groove 32 is located between the lower leg housing 22 and the lower leg output connecting rod 18. This enables internal wiring of the lower leg assembly 6, making the overall appearance of the robot cleaner.

As shown in FIGS. 2, 3, and 5, the lower leg auxiliary connecting rod 19 includes a first lower leg auxiliary portion 33, a second lower leg auxiliary portion 34, and a lower leg auxiliary connecting portion 35. The first lower leg auxiliary portion 33 includes a stepped circular portion 36 and an arc-shaped plate portion 37. The stepped circular portion 36 is inserted into the first torso motor seat 17 and is rotatably connected to the first torso bearing seat 24 through the first torso bearing. The arc-shaped plate portion 37 is integrally connected to one end of the stepped circular portion 36 facing away from the first torso motor seat 17, and is configured to connect the first lower leg auxiliary portion 33 to the lower leg auxiliary connecting portion 35. The second lower leg auxiliary portion 34 is a stepped circular structure and includes a small-diameter end 38 and a large-diameter end 39. The small-diameter end 38 of the second lower leg auxiliary portion 34 is inserted into the second torso motor seat 21, and the large-diameter end 39 of the second lower leg auxiliary portion 34 is disposed on a circular end surface of the second torso motor seat 21 facing away from the second lower leg output portion 26 and is securely connected to the second torso motor seat 21 by bolts. As such, the stepped circular structure of the second lower leg auxiliary portion 34 increases the contact surface between the lower leg auxiliary connecting rod 19 and the second torso motor seat 21, thereby providing a more stable connection between the lower leg auxiliary connecting rod 19 and the second torso motor seat 21. As such, the second lower leg output portion 26 and the second lower leg auxiliary portion 34 are securely disposed at the two ends of the second torso motor seat 21 respectively so that the second torso motor seat 21 is secured to a tail end of the lower leg assembly 6, thereby enabling a rotatable connection between the lower leg assembly 6 and the thigh assembly 7. In addition, two ends of the lower leg auxiliary connecting portion 35 along the first direction are integrally connected to the first lower leg auxiliary portion 33 and the second lower leg auxiliary portion 34 respectively and are symmetrically disposed with respect to the lower leg output connecting portion 27. Moreover, a middle portion of the lower leg auxiliary connecting portion 35 along the first direction is provided with an auxiliary notch 40, so as to provide a mounting position for the lower leg auxiliary connecting rod 19, thereby enabling a larger contact and securing connection surface between the lower leg auxiliary connecting portion 35 and the lower leg auxiliary connecting rod 19. Further, a side surface of the lower leg auxiliary connecting portion 35 facing away from the lower leg output connecting rod 18 in the third direction is formed with a lower leg auxiliary wire groove 41, and the lower leg auxiliary wire groove 41 extends from one end of the arc-shaped plate portion 37 to one end of the second lower leg auxiliary portion 34. A lower leg housing 22 is disposed on the outer surface of the lower leg auxiliary connecting rod 19, that is, the lower leg auxiliary wire groove 41 is located between the lower leg housing 22 and the lower leg auxiliary connecting rod 19. This enables the internal wiring of the lower leg assembly 6, making the overall appearance of the robot cleaner.

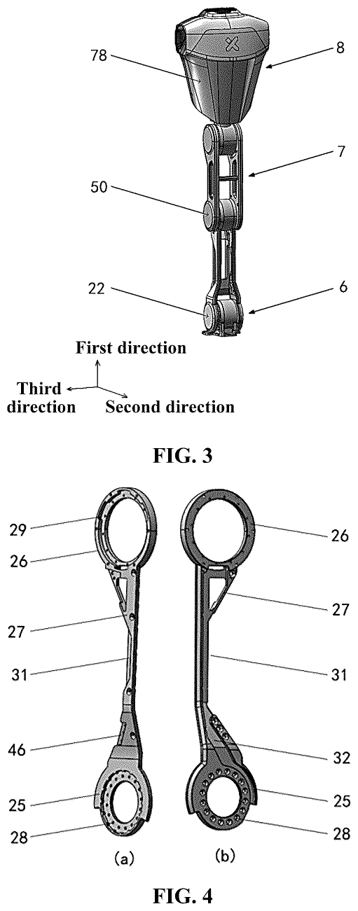

As shown in FIGS. 3 to 6, the lower leg connecting support rod 20 includes a first connecting portion 42, a second connecting portion 43, and a third connecting portion 44. Two ends of the first connecting portion 42 along the third direction are integrally connected to the second connecting portion 43 and the third connecting portion 44 respectively. The second connecting portion 43 and the third connecting portion 44 are both perpendicular to the first connecting portion 42 and extend in the same direction. The second connecting portion 43 and the third connecting portion 44 are symmetrically disposed at the output notch 31 and the auxiliary notch 40 respectively. In the specific implementation, the second connecting portion 43 and the third connecting portion 44 may be positioned with and mounted onto the output notch 31 and the auxiliary notch 40 using positioning blocks and positioning groove structures respectively, thereby providing assembly efficiency and connection stability. Further, two ends of the second connecting portion 43 along the first direction and two ends of the third connecting portion 44 along the first direction are each provided with at least one securing block 45, the lower leg output connecting portion 27 and the lower leg auxiliary connecting portion 35 are each formed with multiple securing grooves 46, and each securing groove 46 is in one-to-one correspondence with respective multiple securing blocks 45. The respective multiple securing blocks 45 are engaged within each securing groove 46 so that a positioning connection is enabled between the lower leg connecting support rod 20, the lower leg output connecting rod 18, and the lower leg auxiliary connecting rod 19. Furthermore, multiple securing blocks 45 are securely connected to the lower leg output connecting portion 27 or the lower leg auxiliary connecting portion 35 by bolts so that the lower leg connecting support rod 20 is securely connected to the lower leg output connecting rod 18 and the lower leg auxiliary connecting rod 19. In the specific implementation, securing blocks 45 disposed at the two ends of the second connecting portion 43 differ in the shape size; likewise, securing blocks 45 disposed at the two ends of the third connecting portion 44 also differ in the shape size, thereby further avoiding misassembly. In addition, the distance from one end of the lower leg output connecting rod 18 facing the first torso motor 11 to one end of the lower leg auxiliary connecting rod 19 facing the first torso motor 11 is larger than the distance from one end of the lower leg output connecting rod 18 facing the second torso motor 12 to one end of the lower leg auxiliary connecting rod 19 facing the second torso motor 12. One end of the lower leg output connecting portion 27 facing the second torso motor 12 is a vertical rod, and one end of the lower leg output connecting portion 27 facing the first torso motor 11 is an inclined rod at a certain angle. The lower leg auxiliary connecting portion 35 is disposed in the same manner, so as to satisfy the mounting requirements of portions and to make the overall structure more aesthetically pleasing.

In some other embodiments, as shown in FIGS. 1, 2, and 8, the thigh assembly 7 further includes a second torso bearing, a thigh output connecting rod 47, a thigh auxiliary connecting rod 48, a thigh connecting support rod 49, and thigh housings 50. Specifically, the second torso motor 12 is mounted onto the second torso motor seat 21, the output shaft of the second torso motor 12 extends along the third direction, and both the output shaft of the second torso motor 12 and a motor tail cover of the second torso motor 12 penetrate through the second torso motor seat 21 to the outside of the second torso motor seat 21. Moreover, the second torso bearing is disposed within the second torso motor seat 21 and is located at one end of the motor tail cover of the second torso motor 12. A first end of the thigh output connecting rod 47 is securely connected to the output shaft of the second torso motor 12, a first end of the thigh auxiliary connecting rod 48 is rotatably connected to the second torso motor seat 21 through the second torso bearing, and a second end of the thigh output connecting rod 47 and a second end of the thigh auxiliary connecting rod 48 are rotatably connected to the thoracic cavity assembly 8. As such, the second torso motor 12 drives the thigh output connecting rod 47 to rotate to enable a thigh portion of the robot to perform a bending action. The thigh auxiliary connecting rod 48 assists the rotation of the thigh output connecting rod 47, and two ends of the thigh connecting support rod 49 along the third direction are securely connected to the thigh output connecting rod 47 and the thigh auxiliary connecting rod 48 respectively so that the thigh auxiliary connecting rod 48 is indirectly secured to the thigh output connecting rod 47. This further ensures the support strength and rotary stability of the thigh portion and also reduces the overall cost of the robot. In addition, an outer surface of the thigh output connecting rod 47 and an outer surface of the thigh auxiliary connecting rod 48 are provided with the thigh housings 50 respectively to make the thigh portion of the robot more aesthetically pleasing.

In a specific embodiment, as shown in FIGS. 2, 8, and 9, the thigh output connecting rod 47 includes a first thigh output portion 51, a second thigh output portion 52, and a thigh output connecting portion 53. The first thigh output portion 51 is an annular plate structure, and multiple second output mounting holes 54 are evenly and equidistantly spaced apart along a circumferential direction of the first thigh output portion 51. The thigh output connecting rod 47 is securely connected to the output shaft of the second torso motor 12 through the multiple second output mounting holes 54 using bolts. The second thigh output portion 52 is an annular plate structure, and multiple third output mounting holes 55 are evenly and equidistantly spaced apart along a circumferential direction of the second thigh output portion 52. The thigh output connecting rod 47 is securely connected to the output shaft of the third torso motor 13 through the multiple third output mounting holes 55 using bolts. Moreover, two ends of the thigh output connecting portion 53 along the first direction are integrally connected to the first thigh output portion 51 and the second thigh output portion 52 respectively, thereby forming a main rotary member of the second torso motor 12. In addition, a side surface of the thigh output connecting portion 53 facing away from the thigh auxiliary connecting rod 48 is formed with a thigh output wire groove 56. The thigh output wire groove 56 extends from one end of the first thigh output portion 51 facing away from the thigh output connecting portion 53 to one end of the second thigh output portion 52 facing away from the thigh output connecting portion 53. A thigh housing 50 is disposed on the outer surface of the thigh output connecting rod 47, that is, the thigh output wire groove 56 is located between the thigh housing 50 and the thigh output connecting rod 47. As such, this enables internal wiring of the thigh assembly 7, making the overall appearance of the robot cleaner. Further, the thigh output connecting rod 47 may be formed with a thigh housing positioning groove 351, and the thigh housing 50 may be provided with a positioning block matching the thigh housing positioning groove 351, so as to enable a positioning connection between the thigh housing 50 and the thigh output connecting rod 47.

As shown in FIGS. 2, 8, and 10, the thigh auxiliary connecting rod 48 includes a first thigh auxiliary portion 57, a second thigh auxiliary portion 58, and a thigh auxiliary connecting portion 59. The first thigh auxiliary portion 57 is a three-stepped circular structure and includes a small-diameter end 60, a medium-diameter end 61, and a large-diameter end 62. The small-diameter end 60 of the first thigh auxiliary portion 57 and the medium-diameter end 61 of the first thigh auxiliary portion 57 are inserted into the second torso motor seat 21 and are rotatably connected to the second torso motor seat 21 through the second torso bearing. The second thigh auxiliary portion 58 is also a three-stepped circular structure and includes a small-diameter end 63, a medium-diameter end 64, and a large-diameter end 65. The small-diameter end 63 of the second thigh auxiliary portion 58 and the medium-diameter end 64 of the second thigh auxiliary portion 58 are inserted into the third torso motor seat 14 and are rotatably connected to the third torso motor seat 14 through the third torso bearing. Moreover, two ends of the thigh auxiliary connecting portion 59 along the first direction are integrally connected to the large-diameter end 62 of the first thigh auxiliary portion 57 and the large-diameter end 65 of the second thigh auxiliary portion 58 respectively, thereby forming an auxiliary rotary member of the second torso motor 12. In addition, a side surface of the thigh auxiliary connecting portion 59 facing away from the thigh output connecting rod 47 is formed with a thigh auxiliary wire groove 66. The thigh auxiliary wire groove 66 extends from one end of the first thigh auxiliary portion 57 facing away from the thigh auxiliary connecting portion 59 to one end of the second thigh auxiliary portion 58 facing away from the thigh auxiliary connecting portion 59. A thigh housing 50 is disposed on the outer surface of the thigh auxiliary connecting rod 48, that is, the thigh auxiliary wire groove 66 is located between the thigh housing 50 and the thigh auxiliary connecting rod 48, thereby enabling the internal wiring of the thigh assembly 7, and making the overall appearance of the robot cleaner. Further, the end of the first thigh output portion 51 facing away from the thigh output connecting portion 53, the end of the second thigh output portion 52 facing away from the thigh output connecting portion 53, the end of the first thigh auxiliary portion 57 facing away from the thigh auxiliary connecting portion 59, and the end of the second thigh auxiliary portion 58 facing away from the thigh auxiliary connecting portion 59 are each provided with a thigh wiring notch 67 so that the design of the thigh wiring notch 67 further facilitates the internal wiring of the robot.

In some specific embodiments of the present disclosure, a wire harness securing block structure may also be provided between the thigh housing 50 and the thigh auxiliary connecting rod 48, and a wire harness securing block structure may also be provided between the lower leg housing 22 and the lower leg auxiliary connecting rod 19, so as to ensure the wiring of multiple wire harnesses within the thigh auxiliary wire groove 66 or the lower leg auxiliary wire groove 41, thereby preventing the wire harnesses from being exposed.

As shown in FIGS. 8, 9, and 10, the thigh connecting support rod 49 is an elongated rod structure and extends along the third direction. Two ends of the thigh connecting support rod 49 are securely connected to a middle portion of the thigh output connecting portion 53 and a middle portion of the thigh auxiliary connecting portion 59 by bolts respectively, thereby indirectly securing the thigh output connecting rod 47 and the thigh auxiliary connecting rod 48 and improving the rotary reliability of the thigh assembly 7.

Further, as shown in FIGS. 2, 8, 9, and 10, the thigh connecting support rod 49 is located on one side of the thigh output connecting portion 53 and one side of the thigh auxiliary connecting portion 59, one side of the thigh output connecting portion 53 facing the thigh connecting support rod 49 is tangent to the first thigh output portion 51 and the second thigh output portion 52, and the other side of the thigh output connecting portion 53 facing away from the thigh connecting support rod 49 is provided with an output limiting portion 68 and an output groove 69. The output limiting portion 68 is tangent to the second thigh output portion 52, the output groove 69 is located at the junction between the thigh output connecting portion 53 and the first thigh output portion 51, and the output groove 69 is connected to the output limiting portion 68 through a transition straight line. Similarly, one side of the thigh auxiliary connecting portion 59 facing the thigh connecting support rod 49 is tangent to the first thigh auxiliary portion 57 and the second thigh auxiliary portion 58, and the other side of the thigh auxiliary connecting portion 59 facing away from the thigh connecting support rod 49 is provided with an auxiliary limiting portion 70 and an auxiliary groove 71. The auxiliary limiting portion 70 is tangent to the second thigh auxiliary portion 58, the auxiliary groove 71 is located at the junction between the thigh auxiliary connecting portion 59 and the first thigh auxiliary portion 57, and the auxiliary groove 71 is connected to the auxiliary limiting portion 70 through a transition straight line. As such, when the second torso motor 12 operates to drive other components of the thigh assembly 7 to rotate, the thigh connecting support rod 49 abuts against the lower leg output connecting rod 18 and the lower leg auxiliary connecting rod 19 to limit the forward tilting rotation of the thigh assembly 7, and the output limiting portion 68 and the auxiliary limiting portion 70 abut against the lower leg connecting support rod 20 to limit the backward tilting rotation of the thigh assembly 7.

In some embodiments, as shown in FIGS. 1, 2, and 11 to 21, the thoracic cavity assembly 8 further includes a third torso bearing, a thoracic cavity bracket 72, a left arm mounting base 73, a right arm mounting base 74, a host mounting frame 75, a controller mounting frame 76, a head mounting base 77, and a thoracic cavity housing 78. Specifically, the third torso bearing is disposed within the third torso motor seat 14 and is located at one end of a motor tail cover of the third torso motor 13, and one end of the thigh assembly 7 facing the thoracic cavity assembly 8 is rotatably connected to the third torso motor seat 14 through the third torso bearing and the third torso motor 13. Moreover, one end of the thoracic cavity bracket 72 along the first direction is securely connected to a stator of the fourth torso motor 15, thereby connecting the thigh assembly 7 to the thoracic cavity assembly 8. In addition, the head mounting base 77 is disposed at the other end of the thoracic cavity bracket 72 along the first direction and is configured for the head structure 2 to be mounted onto. The left arm mounting base 73 and the right arm mounting base 74 are disposed at two ends of the thoracic cavity bracket 72 along the third direction respectively and are both located at one end of the thoracic cavity bracket 72 facing the head mounting base 77 along the first direction, and the robot arms 3 are securely mounted onto the left arm mounting base 73 and the right arm mounting base 74 respectively. The host mounting frame 75 and the controller mounting frame 76 are both disposed at a middle portion of the thoracic cavity bracket 72 along the first direction, the host mounting frame 75 is configured for the PC host 9 and a torso radiator 352 to be mounted onto, and the controller mounting frame 76 is configured for the robotic controller 10 and a main data interface 353 connected to the robotic controller 10 to be mounted onto. The thoracic cavity housing 78 is securely connected to the thoracic cavity bracket 72, and the fourth torso motor 15, the thoracic cavity bracket 72, the left arm mounting base 73, the right arm mounting base 74, the host mounting frame 75, the controller mounting frame 76, and the head mounting base 77 are all disposed within the thoracic cavity housing 78 so that the torso structure 1 is securely connected to other structures of the robot through the head mounting base 77, the left arm mounting base 73, the right arm mounting base 74, the host mounting frame 75, and the controller mounting frame 76.

In some other embodiments, the thoracic cavity assembly 8 further includes the third torso bearing, the thoracic cavity bracket 72, the left arm mounting base 73, the right arm mounting base 74, multiple controller mounting frames 76, the head mounting base 77, and the thoracic cavity housing 78. The difference from the preceding embodiment is that a host mounting frame 75 is not provided in the thoracic cavity assembly 8. The PC host 9 in this embodiment may be disposed in the chassis driving structure 5 to lower the center of gravity to make the overall structure of the robot more stable.

In a specific embodiment, as shown in FIGS. 2 and 11 to 14, the thoracic cavity bracket 72 includes a thoracic cavity bottom plate 79, a left thoracic cavity rib plate 80, a right thoracic cavity rib plate 81, a middle thoracic cavity rib plate 82, multiple thoracic cavity ribs 83, and a housing bracket 84. The thoracic cavity bottom plate 79 includes a motor connecting portion 85 and a rib plate connecting portion 86. The motor connecting portion 85 is configured to securely connect the thoracic cavity bracket 72 to the fourth torso motor 15, and the rib plate connecting portion 86 is configured to securely connect other components of the thoracic cavity bracket 72. Specifically, the motor connecting portion 85 is a circular cylindrical structure, and multiple motor mounting holes 87 are evenly and equidistantly spaced apart along a circumferential direction of the motor connecting portion 85. The motor connecting portion 85 is sleeved onto the fourth torso motor 15 and is securely connected to the stator of the fourth torso motor 15 through the multiple motor mounting holes 87. The rib plate connecting portion 86 is a hexagonal plate structure with two sets of parallel edges, and the lengths of two inclined edges of the rib plate connecting portion 86 are equal. One side of the longest edge of the rib plate connecting portion 86 is provided with an arc notch 88. One end of the motor connecting portion 85 is disposed within the arc notch 88 and is integrally connected to the rib plate connecting portion 86. The remaining five edges of the rib plate connecting portion 86 are securely connected to other components of the thoracic cavity bracket 72 respectively. The left thoracic cavity rib plate 80 includes a left vertical portion 89 and a left horizontal portion 90. The left vertical portion 89 extends along the first direction, and one end of the left vertical portion 89 is securely connected to an end surface of the thoracic cavity bottom plate 79 facing away from the third torso motor 13 and is located at the edge of one of edges of the rib plate connecting portion 86 adjacent to the longest edge of the rib plate connecting portion 86. The length of the end of the left vertical portion 89 is equal to the length of one edge of the rib plate connecting portion 86 adjacent to the longest edge of the rib plate connecting portion 86. The other end of the left vertical portion 89 is integrally connected to one end of the left horizontal portion 90, the left vertical portion 89 is perpendicular to the left horizontal portion 90, and the left horizontal portion 90 extends along the second direction. Moreover, the right thoracic cavity rib plate 81 is symmetrically disposed with respect to the left thoracic cavity rib plate 80. That is, the right thoracic cavity rib plate 81 includes a right vertical portion 91 and a right horizontal portion 92. The right vertical portion 91 extends along the first direction, and one end of the right vertical portion 91 is securely connected to the end surface of the thoracic cavity bottom plate 79 facing away from the third torso motor 13 and is located at the edge of the other one of the edges of the rib plate connecting portion 86 adjacent to the longest edge of the rib plate connecting portion 86. The length of the end of the right vertical portion 91 is equal to the length of the edge of the rib plate connecting portion 86 adjacent to the longest edge of the rib plate connecting portion 86. The other end of the right vertical portion 91 is integrally connected to one end of the right horizontal portion 92, the right vertical portion 91 is perpendicular to the right horizontal portion 92, and the right horizontal portion 92 extends along the second direction. The middle thoracic cavity rib plate 82 is a rectangular plate structure. A middle portion of the middle thoracic cavity rib plate 82 is provided with a rectangular notch 93 to reduce the overall weight of the torso structure 1. One of wide-edge ends of the middle thoracic cavity rib plate 82 is securely connected to the end surface of the thoracic cavity bottom plate 79 facing away from the third torso motor 13 and is located at the edge of one edge of the rib plate connecting portion 86 parallel to the longest edge of the rib plate connecting portion 86. The length of a wide edge of the middle thoracic cavity rib plate 82 is equal to the length of the edge of the rib plate connecting portion 86 parallel to the longest edge of the rib plate connecting portion 86. Further, the multiple thoracic cavity ribs 83 are symmetrically disposed between the middle thoracic cavity rib plate 82, the left thoracic cavity rib plate 80, and the right thoracic cavity rib plate 81. One end of each thoracic cavity rib 83 is securely connected to a long-edge end of the middle thoracic cavity rib plate 82, and the other end of each thoracic cavity rib 83 is securely connected to the left vertical portion 89 or the right vertical portion 91. Two thoracic cavity ribs 83 are secured to the edges of two edges of the rib plate connecting portion 86. In addition, the head mounting base 77 is a rectangular plate structure. Two wide-edge ends of the head mounting base 77 are securely connected to the left horizontal portion 90 and the right horizontal portion 92 by bolts respectively. The head structure 2 is mounted at a middle portion of the head mounting base 77 along the third direction. The left arm mounting base 73 is securely connected to the other end of the left vertical portion 89 connected to the left horizontal portion 90 by bolts, and the right arm mounting base 74 is securely connected to the other end of the right vertical portion 91 connected to the right horizontal portion 92 by bolts. The host mounting frame 75 and the controller mounting frame 76 are both securely connected to the middle thoracic cavity rib plate 82 by bolts, and in the first direction, the controller mounting frame 76 is located between the host mounting frame 75 and the head mounting base 77. The thoracic cavity housing 78 is securely connected to the left thoracic cavity rib plate 80, the right thoracic cavity rib plate 81, and the head mounting base 77 through the housing bracket 84 using bolts.

Further, as shown in FIGS. 2 and 11 to 21, the thoracic cavity housing 78 includes a front shoulder housing 94, a rear shoulder housing 95, a front chest housing 96, a rear chest housing 97, a front bottom housing 98, and a rear bottom housing 99. Correspondingly, the housing bracket 84 includes two first housing mounting frames 100, two second housing mounting frames 101, two third housing mounting frames 102, and two fourth housing mounting frames 103. Each first housing mounting frame 100 is a triangular plate structure. Right-angle edges of the two first housing mounting frames 100 are integrally connected to the left vertical portion 89 and the right vertical portion 91 respectively and are located at one end of the left vertical portion 89 facing the rib plate connecting portion 86 and one end of the right vertical portion 91 facing the rib plate connecting portion 86 respectively. The other right-angle edges of the two first housing mounting frames 100 are away from the rib plate connecting portion 86 and are parallel to the rib plate connecting portion 86. The two first housing mounting frames 100 are located on the same horizontal planes as the left vertical portion 89 and the right vertical portion 91 respectively. Along a respective right-angle edge parallel to the rib plate connecting portion 86, each first housing mounting frame 100 is sequentially provided with a first housing mounting hole 104 and a second housing mounting hole 105, and the first housing mounting hole 104 is disposed away from the left vertical portion 89 or the right vertical portion 91. Moreover, each third housing mounting frame 102 includes a first bracket portion 106, a second bracket portion 107, and a third bracket portion 108. Two ends of the second bracket portion 107 are perpendicularly connected to one end of the first bracket portion 106 and one end of the third bracket portion 108 respectively. The first bracket portion 106 and the third bracket portion 108 are parallel to each other and extend in the same direction. An outer surface of the left vertical portion 89 and an outer surface of the right vertical portion 91 are formed with two bracket limiting grooves 109 respectively. The two bracket limiting grooves 109 are located below the left arm mounting base 73 and the right arm mounting base 74 along the first direction respectively. Each bracket limiting groove 109 is in the shape of n. Two first bracket portions 106 are inserted into the two bracket limiting grooves 109 through opening ends of the two bracket limiting grooves 109 respectively and are securely secured to the left vertical portion 89 and the right vertical portion 91 by bolts respectively. Thus, the two bracket limiting grooves 109 serve to position the two third housing mounting frames 102 and enhance the securing stability of the two third housing mounting frames 102 on the left thoracic cavity rib plate 80 and the right thoracic cavity rib plate 81. The third bracket portion 108 is sequentially provided with a fifth housing mounting hole 110 and a sixth housing mounting hole 111 along the second direction, and the fifth housing mounting hole 110 is disposed away from the left vertical portion 89 or the right vertical portion 91. As such, the front chest housing 96 is securely connected to the rear chest housing 97 through the two first housing mounting frames 100 and the two third housing mounting frames 102. In addition, the two second housing mounting frames 101 are provided on outer surfaces of the two first housing mounting frames 100 respectively and are located at the edges of beveled edges of the two first housing mounting frames 100 respectively. Third housing mounting holes 112 are provided on end surfaces of the two second housing mounting frames 101 located at the beveled edges of the two first housing mounting frames 100 respectively, and fourth housing mounting holes 113 are provided on end surfaces of the two second housing mounting frames 101 facing the rib plate connecting portion 86 respectively. As such, the front bottom housing 98 is securely connected to the rear bottom housing 99 through the two second housing mounting frames 101. Each fourth housing mounting frame 103 is a rectangular plate structure. The two fourth housing mounting frames 103 are both disposed on the head mounting base 77 and are located on two sides of the head structure 2 respectively. At least one seventh housing mounting hole 114 is provided on a side surface of each fourth housing mounting frame 103 facing away from the head structure 2, and one eighth housing mounting hole 115 is provided on an end surface of each fourth housing mounting frame 103 facing away from the head mounting base 77. As such, the front shoulder housing 94 is securely connected to the rear shoulder housing 95 through the two fourth housing mounting frames 103. Specifically, two first housing securing frames 116 are provided within the front shoulder housing 94 and both extend along the second direction. Each first housing securing frame 116 is provided with at least one first securing hole 117. The two first housing securing frames 116 are in one-to-one correspondence with the two fourth housing mounting frames 103. The at least one first securing hole 117 corresponds to the at least one seventh housing mounting hole 114 respectively. Each first housing securing frame 116 is attached to a side surface of a respective fourth housing mounting frame 103 and is securely connected to the at least one first securing hole 117 through the at least one seventh housing mounting hole 114 using bolts, thereby securing the front shoulder housing 94 to the thoracic cavity bracket 72. Two second securing holes 118 are provided on the rear shoulder housing 95 and are in one-to-one correspondence with two eighth housing mounting holes 115. The rear shoulder housing 95 is securely connected to the fourth housing mounting frames 103 through the second securing holes 118 and the eighth housing mounting holes 115 using bolts. In the specific implementation, the front shoulder housing 94 is first securely connected to the thoracic cavity bracket 72, and then the rear shoulder housing 95 is assembled and mounted onto the thoracic cavity bracket 72. As a result, only the second securing holes 118 on the rear shoulder housing 95 are exposed on an outer surface of the thoracic cavity housing 78, thereby minimizing the exposure of mounting bolts. Two second housing securing frames 119 and two third housing securing frames 120 are provided within the front chest housing 96 and all extend along the second direction. Each second housing securing frame 119 is provided with a third securing hole 121 and a fourth securing hole 122, and the two second housing securing frames 119 are in one-to-one correspondence with the two first housing mounting frames 100. The third securing hole 121 corresponds to the first housing mounting hole 104, and the fourth securing hole 122 corresponds to the second housing mounting hole 105. Each second housing securing frame 119 is attached to an outer surface of a respective first housing mounting frame 100 and abuts against an end surface of a respective second housing mounting frame 101 facing away from the rib plate connecting portion 86. Each second housing securing frame 119 is securely connected to the respective first housing mounting frame 100 through the first housing mounting hole 104 and the third securing hole 121 using bolts. Similarly, each third housing securing frame 120 is provided with a fifth securing hole 123 and a sixth securing hole 124, and the two third housing securing frames 120 are in one-to-one correspondence with the two third housing mounting frames 102. The fifth securing hole 123 corresponds to the fifth housing mounting hole 110, and the sixth securing hole 124 corresponds to the sixth housing mounting hole 111. Each third housing securing frame 120 is attached to a respective third bracket portion 108 and is securely connected to the respective third bracket portion 108 through the fifth housing mounting hole 110 and the fifth securing hole 123 using bolts. In addition, two fourth housing securing frames 125 and two fifth housing securing frames 126 are provided within the rear chest housing 97 and all extend along the second direction and a direction facing away from the rear chest housing 97. Each fourth housing securing frame 125 is provided with a seventh securing hole 127, and the two fourth housing securing frames 125 are in one-to-one correspondence with the two second housing securing frames 119. The seventh securing hole 127 corresponds to the fourth securing hole 122. Each fourth housing securing frame 125 is attached to a respective second housing securing frame 119. Each fourth housing securing frame 125, the respective second housing securing frame 119, and a respective first housing mounting frame 100 are securely connected through a bolt that sequentially penetrates through the seventh securing hole 127, the fourth securing hole 122, and the second housing mounting hole 105. Similarly, each fifth housing securing frame 126 is provided with an eighth securing hole 128, and the two fifth housing securing frames 126 are in one-to-one correspondence with the two third housing securing frames 120. The eighth securing hole 128 corresponds to the sixth securing hole 124. Each fifth housing securing frame 126 is attached to a respective third housing securing frame 120. Each fifth housing securing frame 126, the respective third housing securing frame 120, and a respective third housing mounting frame 102 are securely connected by a bolt that sequentially penetrates through the eighth securing hole 128, the sixth securing hole 124, and the sixth housing mounting hole 111. As such, the fourth housing securing frames 125 cover the second housing securing frames 119 respectively, and the fifth housing securing frames 126 cover the third housing securing frames 120 respectively so that only four mounting holes are exposed in the assembly of the front chest housing 96 and the rear chest housing 97. In addition, the front bottom housing 98 is provided with two ninth securing holes 129, and the two ninth securing holes 129 are in one-to-one correspondence with the two fourth housing mounting holes 113. The front bottom housing 98 is securely connected to the second housing mounting frames 101 through the ninth securing holes 129 and the fourth housing mounting holes 113 using bolts. Moreover, the rear bottom housing 99 is provided with two tenth securing holes 130, and the two tenth securing holes 130 are in one-to-one correspondence with the two third housing mounting holes 112. The rear bottom housing 99 is securely connected to the second housing mounting frames 101 through the tenth securing holes 130 and the third housing mounting holes 112 using bolts. As such, the front bottom housing 98 is securely connected to the rear bottom housing 99.

In addition, the rear shoulder housing 95 may also be provided with a USB interface and a power interface, so as to be connected to the robotic controller 10 in the thoracic cavity assembly 8 through the USB interface and the power interface, thereby fulfilling the functions of power supply and data transmission.

In the embodiments of the present disclosure, as shown in FIGS. 1 and 11 to 21, abutment limiting connections are formed between the front shoulder housing 94 and the rear shoulder housing 95, between the front chest housing 96 and the rear chest housing 97, between the front bottom housing 98 and the rear bottom housing 99, between the front shoulder housing 94 and the front chest housing 96, between the rear shoulder housing 95 and the rear chest housing 97, between the front bottom housing 98 and the front chest housing 96, and between the rear bottom housing 99 and the rear chest housing 97, so as to ensure the connections between adjacent housings. Consequently, an enclosed thoracic cavity structure is formed between the front chest housing 96, the rear chest housing 97, the front shoulder housing 94, the rear shoulder housing 95, the front bottom housing 98, and the rear bottom housing 99. The thoracic cavity bracket 72, the left arm mounting base 73, the right arm mounting base 74, the host mounting frame 75, the controller mounting frame 76, the head mounting base 77, and the fourth torso motor 15 are located within the thoracic cavity structure. Moreover, middle portions of the front shoulder housing 94 and the rear shoulder housing 95 along the third direction form a robotic neck opening for the head structure 2 to penetrate through, ends of the front shoulder housing 94 and the rear shoulder housing 95 facing the left arm mounting base 73 along the third direction form a left arm hole for a left robotic arm 3 to penetrate through, and ends of the front shoulder housing 94 and the rear shoulder housing 95 facing the right arm mounting base 74 along the third direction form a right arm hole for a right robotic arm 3 to penetrate through.

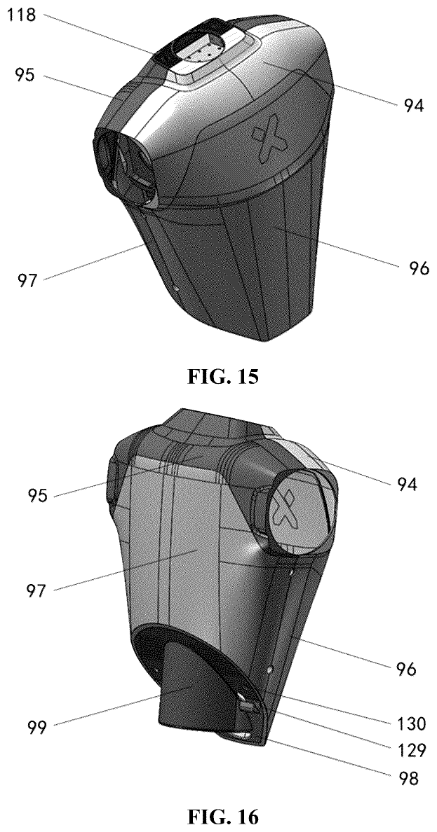

In addition, in the specific implementation, as shown in FIGS. 15 and 18 to 20, an inclined opening is formed between the front chest housing 96 and the rear chest housing 97, and the inclined opening is located on one side of the front bottom housing 98 and one side of the rear bottom housing 99. Specifically, the front bottom housing 98 includes a first front housing portion 131 and a second front housing portion 132. The first front housing portion 131 is a semi-cylindrical housing structure, and one end of the first front housing portion 131 facing the front chest housing 96 is an inclined end surface. The second front housing portion 132 is an inclined plate structure and is integrally connected to the inclined end surface of the first front housing portion 131. The ninth securing holes 129 are provided on the second front housing portion 132. Similarly, the rear bottom housing 99 includes a first rear housing portion 133 and a second rear housing portion 134. The first rear housing portion 133 is a semi-cylindrical housing structure, and one end of the first rear housing portion 133 facing the rear chest housing 97 is an inclined end surface. The second rear housing portion 134 is an inclined plate structure and is integrally connected to the inclined end surface of the first rear housing portion 133. The tenth securing holes 130 are provided on the second rear housing portion 134. An abutment limiting connection is provided between the front bottom housing 98 and the rear bottom housing 99. The first front housing portion 131 and the first rear housing portion 133 jointly form a cylindrical housing structure that is sleeved onto the fourth torso motor seat 16. The fourth torso motor 15 is located within the cylindrical housing structure. The second front housing portion 132 and the second rear housing portion 134 jointly form an inclined plate structure for sealing the inclined opening. Further, the second front housing portion 132 and the second rear housing portion 134 are provided with heat dissipation holes respectively. Moreover, an end surface of the rear shoulder housing 95 facing away from the rear chest housing 97 is also provided with a heat dissipation hole. As such, a straight-through heat dissipation channel is formed from top to bottom, so as to avoid overheating of elements within the thoracic cavity assembly 8 during operation.

In the embodiments of the present disclosure, as shown in FIGS. 22 to 25, the head structure 2 includes a head middle housing 135, a head front housing 145, a head rear housing 153, a head skeleton assembly 155, and a camera 171. The head middle housing 135, the head front housing 145, and the head rear housing 153 jointly form the housing structure of the head structure 2. As an environmental sensing component of the head structure 2, the camera 171 is disposed within the housing structure. The head skeleton assembly 155 is configured to connect the head structure 2 to the torso structure 1, support the head structure 2, and provide a securing mounting position for the camera 171. Specifically, the head middle housing 135 is a housing structure having openings at two ends along the second direction, the head front housing 145 is mounted at one of opening ends of the head middle housing 135, and the head rear housing 153 is mounted at the other one of the opening ends of the head middle housing 135 so that the head front housing 145, the head middle housing 135, and the head rear housing 153 are assembled to form an enclosed chamber. In addition, a neck opening 136 is provided on one side surface of the head middle housing 135 along the first direction. The neck opening 136 provides an opening for one end of the head skeleton assembly 155 to be disposed within the chamber of the housing structure. The head skeleton assembly 155 penetrates through the neck opening 136 so that the end of the head skeleton assembly 155 is disposed within the chamber. The end of the head skeleton assembly 155 disposed within the chamber is securely connected to an inner surface of the head middle housing 135. The other end of the head skeleton assembly 155 is located outside the chamber and is connected to the torso structure 1, thereby providing securing support for the housing structure. Moreover, the end of the head skeleton assembly 155 disposed within the chamber is provided with the securing mounting position for the camera 171. The end of the head skeleton assembly 155 disposed within the chamber is provided with at least one camera 171, the head front housing 145 is provided with a viewing port 146 corresponding to each of the at least one camera 171, and a lens 172 of each of the at least one camera 171 is disposed within the viewing port 146. As such, the lens 172 of each of the at least one camera 171 acquires images or video data of the surrounding environment of the robot through the viewing port 146.

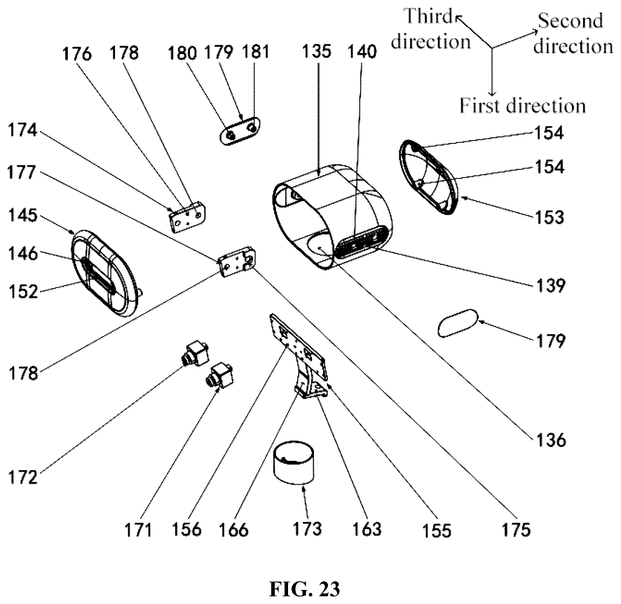

In some embodiments, as shown in FIGS. 22 and 23, the head structure 2 further includes a neck housing 173 to protect a portion of the head skeleton assembly 155 between the head structure 2 of the robot and the torso structure 1 of the robot. Specifically, the neck housing 173 is a tubular structure having openings at two ends along the first direction, one end of the neck housing 173 is disposed at the neck opening 136, and the other end of the neck housing 173 is disposed on the torso structure 1; the other end of the head skeleton assembly 155 located outside the chamber is accommodated within the neck housing 173. As such, the neck housing 173 surrounds and protects the portion of the head skeleton assembly 155 between the head structure 2 of the robot and the torso structure 1 of the robot to prevent the portion of the head skeleton assembly 155 from being directly exposed to the environment, thereby enhancing the overall aesthetic appearance of the robot and extending the service life of associated components of the robot. In the specific implementation, a neck securing plate is provided within the neck housing 173. The neck securing plate is securely connected to the head skeleton assembly 155 by bolts so that the neck housing 173 is securely connected to the head skeleton assembly 155. The end of the neck housing 173 located at the neck opening 136 directly abuts against the housing structure of the neck opening 136 securely, thereby preventing the connecting bolts from being exposed outside the housing, which makes the overall structure more aesthetically pleasing and facilitates assembly and disassembly.

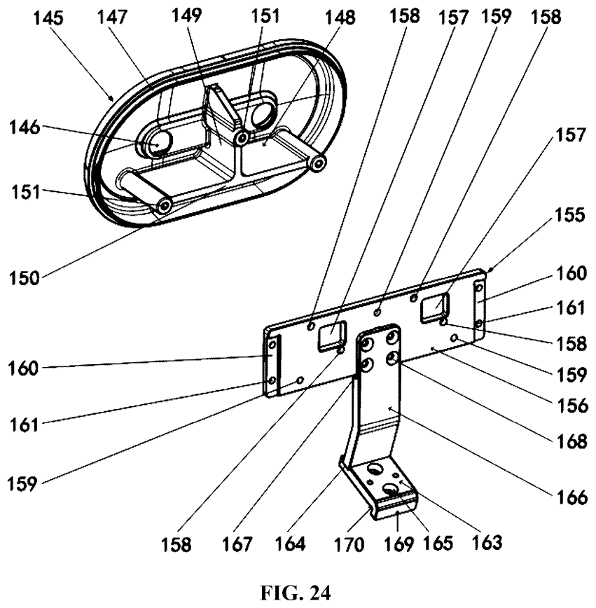

In some other embodiments, as shown in FIGS. 23 and 24, the head skeleton assembly 155 includes a head support skeleton plate 156, a head connecting skeleton plate 163, and a connecting support member 166. As a component of the head skeleton assembly 155, the head support skeleton plate 156 is configured to support the housing structure and provide the securing mounting position for the camera 171. As a component of the head skeleton assembly 155, the head connecting skeleton plate 163 is connected to the torso structure 1. The connecting support member 166 is a connecting component between the head support skeleton plate 156 and the head connecting skeleton plate 163. The head skeleton assembly 155 adopts a multi-component assembled structure, which not only facilitates machining and reduces cost, but also allows compatibility with various types of cameras 171. When the camera 171 is replaced by another type of a camera 171, it is only necessary to use a head support skeleton plate 156 adapted to the new camera 171, thereby further reducing the overall cost of the robot. Specifically, two ends of the connecting support member 166 are connected to the head support skeleton plate 156 and the head connecting skeleton plate 163 respectively, the connecting support member 166 penetrates through the neck opening 136, the head support skeleton plate 156 is located within the chamber, and the head connecting skeleton plate 163 is located outside the chamber. The head support skeleton plate 156 extends along the third direction. Two ends of the head support skeleton plate 156 along the third direction are securely connected to the inner surface of the head middle housing 135 so that the head support skeleton plate 156 supports the housing structure. The at least one camera 171 is disposed on one side surface of the head support skeleton plate 156 facing the head front housing 145 so that the at least one camera 171 is directed toward the head front housing 145, thereby enabling the lens 172 of each of the at least one camera 171 to acquire the images or video data of the surrounding environment of the robot through the viewing port 146 of the head front housing 145. The head connecting skeleton plate 163 is disposed parallel to the plane formed by the second direction and the third direction, and the head structure 2 is securely connected to the torso structure 1 through the head connecting skeleton plate 163 so that the head structure 2 is connected to the torso structure 1. The head connecting skeleton plate 163 is designed to be parallel to the ground, and the contact area between the head connecting skeleton plate 163 and the torso structure 1 is maximized and disposed horizontally, which enhances the load-bearing capacity of the head skeleton assembly 155 and ensures the secure mounting of the head structure 2.

In some specific embodiments, as shown in FIGS. 23 and 24, the at least one camera 171 may be two monocular cameras. The head support skeleton plate 156 is provided with two mounting holes 157 through which ends of the two cameras 171 facing away from lenses 172 are snap-fitted and secured respectively. Multiple first threaded holes 158 are around each mounting hole 157. For example, two first threaded holes 158 may be provided at a pair of diagonal locations of each mounting hole 157. One end of each camera 171 facing away from a respective lens 172 is disposed within a respective mounting hole 157 and is securely connected to the head support skeleton plate 156 through the two first threaded holes 158, thereby securely mounting the two cameras 171 within the head structure 2. In some other specific embodiments, the at least one camera 171 may also be a binocular camera, in which case the head support skeleton plate 156 is designed with a mounting structure adapted to the binocular camera.

Further, in some specific embodiments, as shown in FIGS. 23 and 24, the edge of one side surface of the head front housing 145 facing the head middle housing 135 is formed with a snap-fit slot 147. The snap-fit slot 147 is around the peripheral edge of the head front housing 145, and one of the opening ends of the head middle housing 135 is snap-fitted into the snap-fit slot 147. As such, the snap-fit slot 147 enables a snap-fit positioning connection between the head middle housing 135 and the head front housing 145. In addition, the head middle housing 135 and the head front housing 145 are securely connected through an inverted T-shaped frame 148 and the head support skeleton plate 156 using bolts, thereby stably connecting the head middle housing 135 to the head front housing 145. Specifically, the inverted T-shaped frame 148 includes a vertical portion 149 and a horizontal portion 150, and one end of the vertical portion 149 is integrally connected to a middle portion of the horizontal portion 150. The inverted T-shaped frame 148 is provided on the side surface of the head front housing 145 facing the head middle housing 135. The vertical portion 149 extends along the first direction, and the horizontal portion 150 extends along the third direction. Two viewing ports 146 are located on two sides of the vertical portion 149 of the inverted T-shaped frame 148 along the first direction respectively. Three end portions of the inverted T-shaped frame 148 are provided with three ninth threaded holes 151 respectively. Correspondingly, the head support skeleton plate 156 is provided with three tenth threaded holes 159. The three tenth threaded holes 159 are in one-to-one correspondence with the three ninth threaded holes 151. As such, the head front housing 145 is positioned with and secured to the head middle housing 135 through the snap-fit slot 147 and is further securely connected to the head support skeleton plate 156 through the ninth threaded holes 151 and the tenth threaded holes 159 using bolts, thereby securely connecting the head front housing 145 to the head middle housing 135.

In some other specific embodiments, as shown in FIGS. 23 and 24, the head connecting skeleton plate 163 is a horizontal rectangular plate whose long edge extending along the second direction, and one end of the head connecting skeleton plate 163 along the second direction is formed with a positioning groove 164 that is located on one side surface of the head connecting skeleton plate 163 facing the head support skeleton plate 156 and the connecting support member 166. Moreover, multiple second threaded holes are provided within the positioning groove 164. One end of the connecting support member 166 is positioned within the positioning groove 164. The positioning groove 164 enables a positioning connection between the connecting support member 166 and the head connection skeleton plate 163, and a bolted securing connection between the multiple second threaded holes and the head connecting skeleton plate 163 enables a bolted securing connection between the connecting support member 166 and the head connecting skeleton plate 163.

In addition, as shown in FIG. 24, the other end of the head connecting skeleton plate 163 along the second direction is provided with a snap-fit plate 169. The snap-fit plate 169 is perpendicularly connected to the head connecting skeleton plate 163 and extends along the first direction, specifically in a direction facing away from the head support skeleton plate 156. When the head connecting skeleton plate 163 is connected to the torso structure 1, the snap-fit plate 169 enables the positioning and securing between the head connecting skeleton plate 163 and the torso structure 1. Moreover, a chamfer structure 170 is also provided at the junction between the head connecting skeleton plate 163 and the snap-fit plate 169. As such, the chamfer structure 170 can ensure a smooth positioning connection between the head skeleton assembly 155 and the torso structure 1, thereby preventing a machining problem at the junction between the head skeleton assembly 155 and the torso structure 1 from hindering a contact positioning connection between the head connecting skeleton plate 163, the snap-fit plate 169, and the torso structure 1.

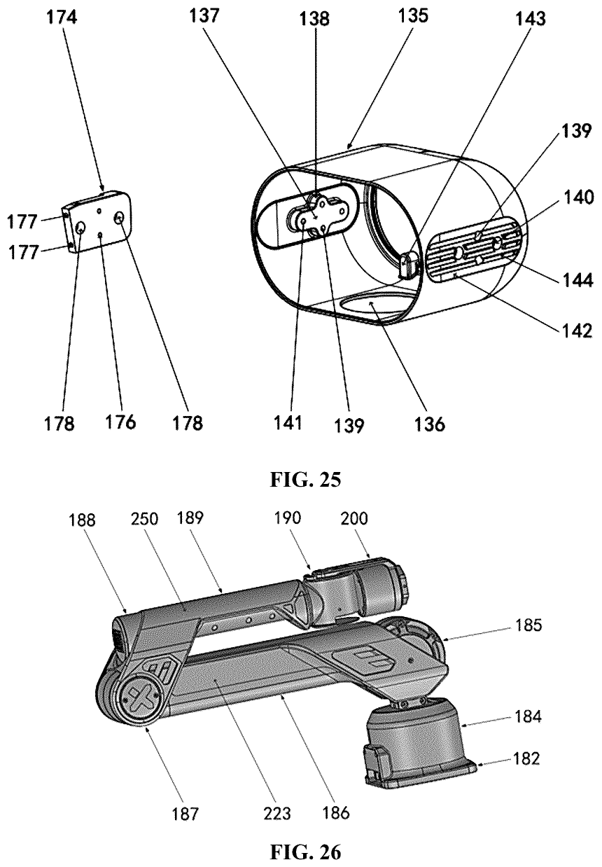

In some embodiments, as shown in FIGS. 23 and 25, the two ends of the head support skeleton plate 156 along the third direction are securely connected to two opposite inner surfaces of the head middle housing 135 along the third direction through connecting plates 174 respectively. Specifically, the two opposite inner surfaces of the head middle housing 135 along the third direction are provided with transverse bosses 137 respectively, and each transverse boss 137 is a racetrack-shaped structure extending along the second direction. Two sides of a middle portion of each transverse boss 137 along the second direction are provided with longitudinal bosses 138 respectively, and each longitudinal boss 138 extends along a direction facing away from a respective transverse boss 137 in the first direction. Each longitudinal boss 138 is provided with a fourth threaded hole 139. Each connecting plate 174 extends along the second direction, and one side surface of each connecting plate 174 facing the head middle housing 135 is formed with a limiting groove 175. The limiting groove 175 is located at one end of each connecting plate 174 along the second direction, and the shape size of the limiting groove 175 is identical to that of one end of a respective transverse boss 137. Each connecting plate 174 is limited and secured to the respective transverse boss 137 through the limiting groove 175. Moreover, each connecting plate 174 is provided with two fifth threaded holes 176 in one-to-one correspondence with two fourth threaded holes 139. Each connecting plate 174 is securely connected to respective longitudinal bosses 138 through the fifth threaded holes 176 and the fourth threaded holes 139 using bolts, thereby securely connecting each connecting plate 174 to the head middle housing 135. Further, one end surface of each connecting plate 174 facing away from the limiting groove 175 is provided with multiple sixth threaded holes 177. One side surface of the head support skeleton plate 156 facing away from the head front housing 145 is formed with two mounting grooves 160. The two mounting grooves 160 are located at the two ends of the head support skeleton plate 156 along the third direction respectively. Multiple seventh threaded holes 161 are provided within each mounting groove 160 and are in one-to-one correspondence with the multiple sixth threaded holes 177. Ends of the two connecting plates 174 facing away from limiting grooves 175 are disposed within the two mounting grooves 160 respectively. Each connecting plate 174 is securely connected to the head support skeleton plate 156 through the sixth threaded holes 177 and the seventh threaded holes 161 using bolts, thereby securely connecting the head support skeleton plate 156 to each connecting plate 174. Accordingly, the head support skeleton plate 156 is securely connected to the head middle housing 135 through each connecting plate 174.

In some specific embodiments, as shown in FIGS. 22, 23, and 25, each fourth threaded hole 139 penetrates through both inner and outer sides of the head middle housing 135. Moreover, the head structure 2 further includes head edge housings 179 that are configured to cover the fourth threaded holes 139, thereby making the entire head structure 2 more aesthetically pleasing. Specifically, two opposite outer surfaces of the head middle housing 135 along the third direction are provided with the head edge housings 179 respectively. One side surface of each head edge housing 179 facing the head middle housing 135 is provided with two securing platforms 180, and each securing platform 180 is provided with an eighth threaded hole 181. An outer surface of the head middle housing 135 is formed with a securing groove 140 corresponding to each securing platform 180. Four securing grooves 140 are located at two ends of the two transverse bosses 137 respectively. A third threaded hole 141 is provided within each securing groove 140, and each third threaded hole 141 penetrates through the inner and outer sides of the head middle housing 135. Each connecting plate 174 is provided with two through holes 178 in one-to-one correspondence with two third threaded holes 141. Each head edge housing 179 is securely connected to the head middle housing 135 through eighth threaded holes 181, the third threaded holes 141, and the through holes 178 using bolts. Further, the two opposite outer surfaces of the head middle housing 135 along the third direction are each provided with a recessed groove 142. The fourth threaded holes 139 and securing grooves 140 are located within the recessed groove 142. The head edge housing 179 has the same shape as the recessed groove 142, and in the first direction, the width of the head edge housing 179 is the same as the width of the recessed groove 142. In addition, multiple strip-shaped racks 144 extending along the second direction are disposed within the recessed groove 142 to decorate the appearance of the head structure 2.

In some other embodiments, as shown in FIGS. 22, 23, and 25, an opening end of the head middle housing 135 facing the head rear housing 153 is provided with multiple first rear housing mounting frames 143. Correspondingly, the head rear housing 153 is provided with multiple second rear housing mounting frames 154 that are in one-to-one correspondence with the multiple first rear housing mounting frames 143. The first rear housing mounting frames 143 and the second rear housing mounting frames 154 are provided with threaded holes respectively. As such, the head middle housing 135 is securely connected to the head rear housing 153 through the first rear housing mounting frames 143 and the second rear housing mounting frames 154 using bolts.

In the embodiments of the present disclosure, in the assembly of the head structure 2, the head connecting skeleton plate 163 is securely connected to the connecting support member 166 through the positioning groove 164 and the second threaded holes using bolts. After being connected, the head connecting skeleton plate 163 and the connecting support member 166 are securely mounted onto the torso structure 1. The neck housing 173 is subsequently sleeved onto the connecting support member 166, and the neck housing 173 is securely connected to the head connecting skeleton plate 163 through the neck securing plate using bolts. Moreover, the head support skeleton plate 156 is securely connected to the connecting plates 174 through sixth threaded holes 177 and seventh threaded holes 161 using bolts. Afterwards, the connecting plates 174 are securely connected to the head middle housing 135 through fifth threaded holes 176 and fourth threaded holes 139 using bolts. The head edge housings 179 are securely connected to two sides of the head middle housing 135 through third threaded holes 141, eighth threaded holes 181, and through holes 178 using bolts. As such, the assembly of the head middle housing 135, the head support skeleton plate 156, the two connecting plates 174, and the two head edge housings 179 is completed. Afterwards, the assembled connecting support member 166 extends into the assembled head middle housing 135 through the neck opening 136, and the connecting support member 166 is securely connected to the head support skeleton plate 156 using bolts. This completes the assembly of the head skeleton assembly 155, the head middle housing 135, the two connecting plates 174, the two head edge housings 179, and the neck housing 173 onto the torso structure 1. Thereafter, the cameras 171 are securely connected to the head support skeleton plate 156 through the mounting holes 157 and first threaded holes 158 using bolts. The head front housing 145 is snap-fitted onto the head middle housing 135 through the snap-fit slot 147, and the head front housing 145 is securely connected to the head middle housing 135 through the ninth threaded holes 151 and the tenth threaded holes 159 using bolts. Moreover, the lenses 172 of the cameras 171 are snap-fitted into the viewing ports 146. Finally, the head rear housing 153 is securely connected to the head middle housing 135 through the second rear housing mounting frames 154 on the head rear housing 153 and the first rear housing mounting frames 143 on the head middle housing 135. Therefore, during testing, maintenance and inspection can be performed simply by accessing the internal structure by removing the head rear housing 153 from the head middle housing 135.

In the embodiments of the present disclosure, as shown in FIGS. 26 to 44, a robotic arm 3 of the robotic arms 3 includes a robotic arm base 182, a robotic arm control board 183, a first joint mechanism 184, a second joint mechanism 185, a robotic upper arm structure 186, a third joint mechanism 187, a fourth joint mechanism 188, a robotic forearm structure 189, a fifth joint mechanism 190, and a sixth joint mechanism 200. Specifically, the robotic arm control board 183 is disposed within the robotic arm base 182, the robotic arm 3 is securely connected to the torso structure 1 through the robotic arm base 182, the robotic upper arm structure 186 is connected to the robotic arm base 182 through the second joint mechanism 185 and the first joint mechanism 184, the robotic forearm structure 189 is connected to the robotic upper arm structure 186 through the fourth joint mechanism 188 and the third joint mechanism 187, the fifth joint mechanism 190 and the sixth joint mechanism 200 are disposed at a tail end of the robotic forearm structure 189, and the robotic forearm structure 189 is connected to a gripper structure 4 through the fifth joint mechanism 190 and the sixth joint mechanism 200. Moreover, the first joint mechanism 184 includes a first arm motor 201, the second joint mechanism 185 includes a second arm motor, the first arm motor 201 is securely mounted onto the robotic arm base 182, an output shaft of the first arm motor 201 is securely connected to the second joint mechanism 185, and an output shaft of the second arm motor is securely connected to the robotic upper arm structure 186. The first arm motor 201 drives the robotic arm 3 to rotate around a central axis paralleled to a central axis of the robotic arm base 182 when operating, the second arm motor drives the robotic upper arm structure 186 to rotate around a central axis of the output shaft of the second arm motor when operating, and the central axis of the output shaft of the second arm motor is perpendicular to a central axis of the robotic arm base 182. The third joint mechanism 187 includes a third arm motor, and the fourth joint mechanism 188 includes a fourth arm motor 202. The third arm motor is securely disposed at a tail end of the robotic upper arm structure 186, an output shaft of the third arm motor is securely connected to the fourth joint mechanism 188, and an output shaft of the fourth arm motor 202 is securely connected to the robotic forearm structure 189. The third arm motor drives the robotic forearm structure 189 to rotate around a central axis of the output shaft of the third arm motor when operating, where the central axis of the output shaft of the third arm motor is parallel to the central axis of the output shaft of the second arm motor, and the fourth arm motor 202 drives the robotic forearm structure 189 to rotate around a central axis of the output shaft of the fourth arm motor 202 when operating, where the central axis of the output shaft of the fourth arm motor 202 is perpendicular to the central axis of the output shaft of the third arm motor. In addition, the fifth joint mechanism 190 includes a fifth arm motor, and the sixth joint mechanism 200 includes a sixth arm motor. The fifth arm motor is securely disposed at a tail end of the robotic forearm structure 189, an output shaft of the fifth arm motor is securely connected to the sixth joint mechanism 200, and an output shaft of the sixth arm motor is securely connected to the gripper structure 4. The fifth arm motor drives the gripper structure 4 to rotate around a central axis of the output shaft of the fifth arm motor when operating, where the central axis of the output shaft of the fifth arm motor is perpendicular to the central axis of the output shaft of the fourth arm motor 202, and the sixth arm motor drives the gripper structure 4 to rotate around a central axis of the output shaft of the sixth arm motor when operating, where the central axis of the output shaft of the sixth arm motor is perpendicular to the central axis of the output shaft of the fifth arm motor. In addition, the robotic arm control board 183 is electrically connected to the first arm motor 201, the second arm motor, the third arm motor, the fourth arm motor 202, the fifth arm motor, and the sixth arm motor, for controlling the actions of the robotic arm 3. It is to be noted that, in the embodiments of the present disclosure, when the robotic arm 3 is extended to the maximum distance, that is, when the robotic upper arm structure 186, the robotic forearm structure 189, and the first joint mechanism 184 extend along the same direction, the central axis of the robotic arm base 182, the central axis of the output shaft of the fourth arm motor 202, and the central axis of the output shaft of the sixth arm motor are aligned on the same straight line.

In some embodiments, the first arm motor 201 drives the robotic arm 3 to rotate around a central axis that is paralleled to a central axis of the robotic arm base 182 and perpendicular to an installation plane, when the first arm motor 201 operates. The installation plane may be a surface of the ground.

In some embodiments, the second arm motor drives the robotic upper arm structure 186 to rotate around a central axis of the output shaft of the second arm motor when operating. The central axis of the output shaft of the second arm motor is perpendicular to the central axis of the robotic arm base 182, and is paralleled to an installation plane. The installation plane may be a surface of the ground.

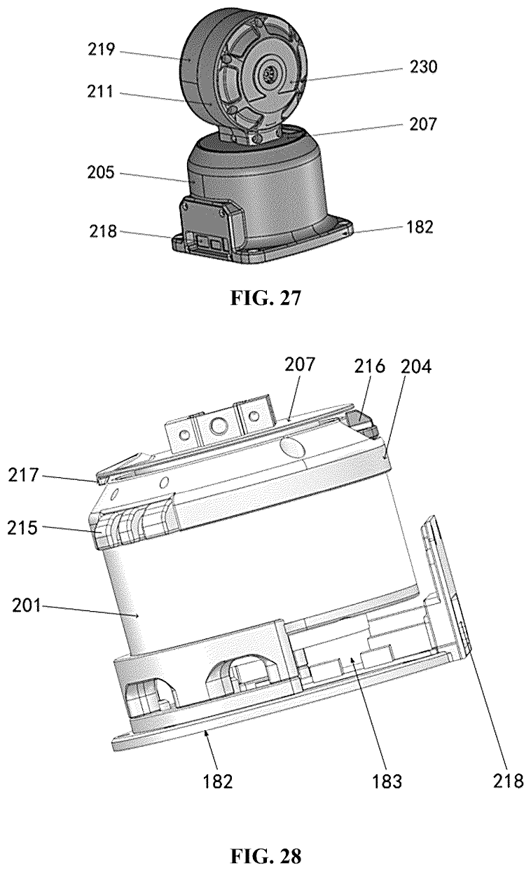

In some embodiments, as shown in FIGS. 27 to 30, the first joint mechanism 184 further includes a first arm bearing, a first arm bearing seat 204, a base housing 205, a first joint output member 206, and a second joint output member 207. The base housing 205 is securely mounted onto the robotic arm base 182. The base housing 205 and the robotic arm base 182 jointly form a cavity structure configured to accommodate the first arm motor 201, the first arm bearing, the first arm bearing seat 204, and the robotic arm control board 183. The first arm motor 201 is securely mounted onto the robotic arm base 182 through a motor mounting bracket, and the robotic arm control board 183 is disposed between the robotic arm base 182 and the motor mounting bracket. Moreover, the first arm bearing is securely mounted onto the first arm motor 201 through the first arm bearing seat 204. To achieve the connection and the torque transmission between the first joint mechanism 184 and the second joint mechanism 185, the second joint mechanism 185 is connected to the output shaft of the first arm motor 201 through the first joint output member 206 and the second joint output member 207. Specifically, the first joint output member 206 is securely mounted onto the output shaft of the first arm motor 201, a middle portion of the first joint output member 206 is provided with a first joint connecting portion 208, each of two ends of the first joint connecting portion 208 extends in a respective direction facing away from the first joint output member 206 along a direction perpendicular to the first joint output member 206, and the first joint connecting portion 208 is provided with a first joint mounting hole 209 penetrating through two opposite end surfaces of the first joint connecting portion 208. The second joint output member 207 is rotatably connected to an opening end of the base housing 205 facing away from the robotic arm base 182 through the first arm bearing to seal the cavity jointly formed by the base housing 205 and the robotic arm base 182. Moreover, a middle portion of the second joint output member 207 is provided with a second joint mounting hole 210 penetrating through the second joint output member 207, and the second joint mounting hole 210 is disposed corresponding to the first joint mounting hole 209. One end of the first joint connecting portion 208 facing the first arm motor 201 is inserted into the output shaft of the first arm motor 201, the other end of the first joint connecting portion 208 facing away from the first arm motor 201 is inserted into the middle portion of the second joint output member 207, and the second joint output member 207, the first joint output member 206, and the output shaft of the first arm motor 201 are securely connected through a bolt that sequentially penetrates through the second joint mounting hole 210 and the first joint mounting hole 209 and is securely connected to the output shaft of the first arm motor 201. Moreover, an end surface of the second joint output member 207 that is located outside the base housing 205 is securely connected to a second arm motor seat 211 of the second arm motor. As such, the first joint mechanism 184 can be connected to the second joint mechanism 185. In the specific implementation, an end surface of the first joint output member 206 facing the second joint output member 207 is also provided with a first joint protruding block 212. Correspondingly, an end surface of the second joint output member 207 facing the first joint output member 206 is formed with a first joint groove. The first joint groove is disposed corresponding to the first joint protruding block 212. The first joint protruding block 212 is snap-fitted into the first joint groove so that a positioning connection can be enabled between the first joint output member 206 and the second joint output member 207, and the contact area between the first joint output member 206 and the second joint output member 207 can be increased, thereby ensuring the stability of the connection between the first joint mechanism 184 and the second joint mechanism 185. In addition, an end surface of the second joint output member 207 that is located within the base housing 205 is formed with a first joint annular groove 213, and the second joint output member 207 is provided with at least one first arm threading hole 214 penetrating through the inside and the outside of the base housing 205. When the first joint output member 206 and the second joint output member 207 are assembled, the formation of the first joint annular groove 213 allows a first wiring gap to be formed between the second joint output member 207, the first joint output member 206, and the first arm motor 201. The first arm bearing seat 204 is provided with a first arm threading block 215 penetrating through the inside and the outside of the first arm bearing seat 204. As such, a wire partially outside the base housing 205 is electrically connected to the robotic arm control board 183 through the at least one first arm threading hole 214, the first wiring gap, the first arm threading block 215, and a housing gap between the first arm motor 201 and the base housing 205. In addition, an outer surface of the first arm bearing seat 204 is provided with a first joint limiting block 216, the second joint output member 207 is provided with a second joint limiting block 217, and the second joint limiting block 217 is disposed corresponding to the first joint limiting block 216. When operating, the first arm motor 201 drives the first joint output member 206 and the second joint output member 207 to rotate. During this process, the first joint limiting block 216 blocks the second joint limiting block 217 to limit the rotation of the output shaft of the first arm motor 201, so as to prevent the wiring within the base housing 205 from becoming entangled and affecting the operation of the first arm motor 201. Further, the base housing 205 is provided with at least one data interface 218 electrically connected to the robotic arm control board 183 so that the robotic arm control board 183 can transmit data through the at least one data interface 218.

In some other embodiments, as shown in FIGS. 26, 27, 29, and 31, the second joint mechanism 185 further includes a second arm bearing, the second arm motor seat 211, and a second arm bearing seat 219. The second arm motor is disposed within the second arm motor seat 211, the second arm bearing is disposed within the second arm bearing seat 219, the second arm motor seat 211 and the second arm bearing seat 219 are engaged and secured, both the second arm motor seat 211 and the second arm bearing seat 219 are securely connected to the output shaft of the first arm motor 201, the output shaft of the second arm motor is securely connected to the robotic upper arm structure 186, and the robotic upper arm structure 186 is rotatably connected to the second arm bearing seat 219 through the second arm bearing, thereby driving the robotic upper arm structure 186 to rotate through the second arm motor.

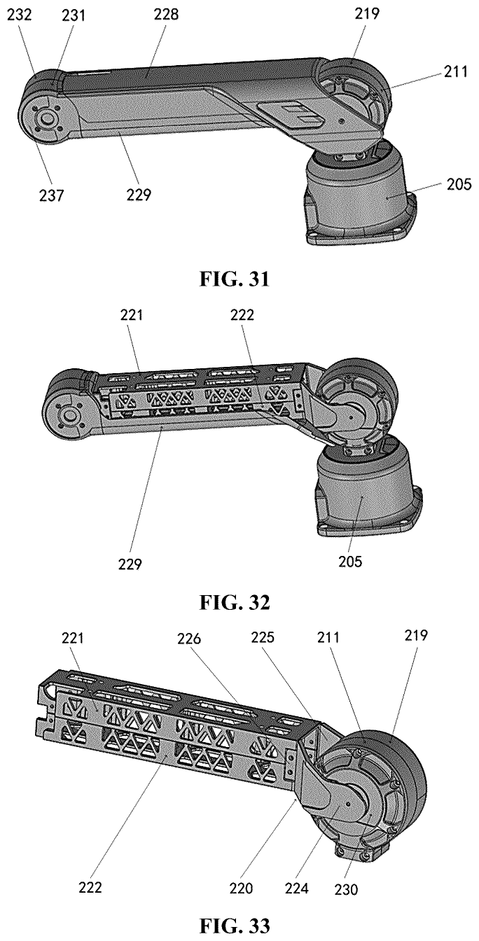

Further, as shown in FIGS. 31 to 34, the robotic upper arm structure 186 includes an upper arm connecting frame 220, an upper arm upper frame 221, an upper arm lower frame 222, and an upper arm housing 223. The upper arm connecting frame 220 includes an upper arm output portion 224 and an upper arm auxiliary portion 225; one end of the upper arm output portion 224 is securely connected to the output shaft of the second arm motor, and one end of the upper arm auxiliary portion 225 is rotatably connected to the second arm bearing seat 219 through the second arm bearing; the other end of the upper arm output portion 224 and the other end of the upper arm auxiliary portion 225 are provided with upper arm mounting plates 226 respectively. As such, the upper arm connecting frame 220 is securely connected to the upper arm upper frame 221 and the upper arm lower frame 222 through two upper arm mounting plates 226. Specifically, each upper arm mounting plate 226 is a rectangular plate structure, two opposite side surfaces of the upper arm upper frame 221 and two opposite side surfaces of the upper arm lower frame 222 are formed with upper arm mounting grooves 227 respectively, and the upper arm upper frame 221 and the upper arm lower frame 222 are symmetrically disposed. When the upper arm upper frame 221 and the upper arm lower frame 222 are engaged and securely connected by bolts, two upper arm mounting grooves 227 on the same side of the upper arm upper frame 221 and the upper arm lower frame 222 jointly form a rectangular groove matching an upper arm mounting plate 226. Each upper arm mounting plate 226 is snap-fitted with respective two upper arm mounting grooves 227 on the same side of the upper arm upper frame 221 and the upper arm lower frame 222, and each upper arm mounting plate 226 is securely connected to the upper arm upper frame 221 and the upper arm lower frame 222 by bolts. As such, the upper arm connecting frame 220, the upper arm upper frame 221, and the upper arm lower frame 222 are securely connected. Moreover, one end of the upper arm upper frame 221 facing away from the upper arm connecting frame 220 and one end of the upper arm lower frame 222 facing away from the upper arm connecting frame 220 are securely connected to the third joint mechanism 187. In addition, through the structural design of the upper arm upper frame 221 and the upper arm lower frame 222 of the robotic upper arm structure 186, a second wiring gap is formed between the upper arm upper frame 221 and the upper arm lower frame 222. A wire of the third joint mechanism 187 is routed through the second wiring gap to the second joint mechanism 185. Moreover, the upper arm housing 223 surrounds the outside of the upper arm upper frame 221 and the outside of the upper arm lower frame 222 so that the robotic upper arm structure 186 has no exposed external wiring, thereby providing a more aesthetic appearance. Further, specifically, the upper arm housing 223 includes an upper arm upper housing 228 and an upper arm lower housing 229, the upper arm lower housing 229 is securely connected to the upper arm lower frame 222 by bolts, the upper arm upper housing 228 is securely connected to the upper arm connecting frame 220 by bolts, and the upper arm upper housing 228 and the upper arm lower housing 229 are engaged so that the upper arm connecting frame 220, the upper arm upper frame 221, and the upper arm lower frame 222 are located within the upper arm housing 223. In addition, an outer surface of the second arm motor seat 211 and an outer surface of the second arm bearing seat 219 are formed with a first joint limiting groove 230, the first joint limiting groove 230 is a groove structure configured to allow a preset rotation angle, and both the upper arm output portion 224 and the upper arm auxiliary portion 225 are disposed within the first joint limiting groove 230. When operating, the second arm motor drives the upper arm output portion 224 and the upper arm auxiliary portion 225 to rotate within the first joint limiting groove 230. As such, the formation of the first joint limiting groove 230 limits the rotation of the output shaft of the second arm motor, thereby avoiding the entanglement of the wire.

In some other embodiments, as shown in FIGS. 26, 32, and 34 to 37, the third joint mechanism 187 further includes a third arm motor seat 231, a third arm bearing, a third arm bearing seat 232, and a first joint connecting frame 233. The third arm motor is securely mounted within the third arm motor seat 231, the third arm bearing is mounted within the third arm bearing seat 232, and the third arm bearing seat 232 and the third arm motor seat 231 are engaged and securely connected. The first joint connecting frame 233 includes a first joint output portion 234, a first joint auxiliary portion 235, and a second joint connecting portion 236, the fourth joint mechanism 188 is disposed on one end surface of the second joint connecting portion 236, one end of the first joint output portion 234 and one end of the first joint auxiliary portion 235 are securely connected to two opposite side surfaces of the second joint connecting portion 236 by bolts respectively, the other end of the first joint output portion 234 is securely connected to the output shaft of the third arm motor, and the other end of the first joint auxiliary portion 235 is rotatably connected to the third arm bearing seat 232 through the third arm bearing, thereby driving the fourth joint mechanism 188 to rotate through the third arm motor. Further, an outer surface of the third arm motor seat 231 and an outer surface of the third arm bearing seat 232 are formed with second joint limiting grooves 237 respectively. Correspondingly, an inner surface of the first joint output portion 234 and an inner surface of the first joint auxiliary portion 235 are provided with third joint limiting blocks 238 respectively, two third joint limiting blocks 238 are in one-to-one correspondence with two second joint limiting grooves 237, and the third joint limiting blocks 238 are disposed within the second joint limiting grooves 237 respectively. When operating, the third arm motor drives the first joint output portion 234 and the first joint auxiliary portion 235 to rotate, and the third joint limiting blocks 238 move within the second joint limiting grooves 237 to limit the rotation of the output shaft of the third arm motor, thereby avoiding the entanglement of the wire.

Further, as shown in FIGS. 38 to 40, the fourth joint mechanism 188 further includes a fourth arm motor seat 239, a fourth arm bearing 240, a fifth arm bearing 241, a fourth arm bearing seat 242, and a joint output shaft 243. The fourth arm motor 202 is securely mounted within the fourth arm motor seat 239, both the fourth arm bearing 240 and the fifth arm bearing 241 are mounted within the fourth arm bearing seat 242, the fourth arm bearing seat 242 and the fourth arm motor seat 239 are engaged and securely connected, one end of the joint output shaft 243 is securely connected to the output shaft of the fourth arm motor 202, and the other end of the joint output shaft 243 is securely connected to the robotic forearm structure 189 through the fourth arm bearing 240 and the fifth arm bearing 241. In the specific implementation, the fifth arm bearing 241 and the fourth arm bearing seat 242 are configured as back-to-back angular contact bearings. Further, the output shaft of the fourth arm motor 202 is provided with a fourth joint limiting block 244, and an inner surface of the fourth arm bearing seat 242 is provided with a fifth joint limiting block 245 corresponding to the fourth joint limiting block 244. When the fourth arm motor 202 operates, the output shaft of the fourth arm motor 202 rotates, and the fifth joint limiting block 245 blocks the fourth joint limiting block 244 to limit the rotation of the output shaft of the fourth arm motor 202, thereby avoiding the entanglement of the wire.

As shown in FIGS. 35 to 43, the robotic forearm structure 189 includes a first forearm connecting rod 246, a second forearm connecting rod 247, a third forearm connecting rod 248, a forearm housing bracket 249, and a forearm housing 250. Two ends of the second forearm connecting rod 247 are securely connected to one end of the first forearm connecting rod 246 and one end of the third forearm connecting rod 248 respectively, the other end of the first forearm connecting rod 246 is securely connected to the other end of the joint output shaft 243, and the other end of the third forearm connecting rod 248 is securely connected to a fifth arm motor seat 251 of the fifth arm motor. As such, torque is transmitted between the fourth joint mechanism 188 and the fifth joint mechanism 190 through the arrangement of the first forearm connecting rod 246, the second forearm connecting rod 247, and the third forearm connecting rod 248. In addition, one end of the forearm housing bracket 249 is securely connected to an end surface of the fourth arm bearing seat 242, the forearm housing 250 is securely connected to the forearm housing bracket 249, and the forearm housing bracket 249 is securely connected to the fourth arm bearing seat 242, and the first forearm connecting rod 246, the second forearm connecting rod 247, the third forearm connecting rod 248, and the forearm housing bracket 249 are all located within the forearm housing 250. Further, specifically, the forearm housing 250 includes a forearm upper housing 252, a forearm lower housing 253, and a forearm snap-fit housing 254. The forearm lower housing 253 is securely connected to the forearm housing bracket 249 by bolts, two opposite ends of an inner surface of the forearm lower housing 253 facing the fifth arm motor are formed with forearm snap-fit slots 255 respectively, the forearm snap-fit housing 254 is provided with two forearm snap-fit blocks 256, the two forearm snap-fit blocks 256 are in one-to-one correspondence with two forearm snap-fit slots 255, the forearm snap-fit blocks 256 are securely snap-fitted within the forearm snap-fit slots 255 respectively, and the forearm snap-fit housing 254 is securely connected to one end of the forearm lower housing 253 to form a circular through hole for the connection of the robotic forearm structure 189 and the fifth joint mechanism 190, thereby facilitating the assembly of the forearm housing 250 by separately providing the forearm snap-fit housing 254 and the forearm lower housing 253. In addition, one end of the forearm upper housing 252 facing the fourth arm motor seat 239 is provided with two forearm connecting snap-fit portions 257, an outer surface of the first joint output portion 234 and an outer surface of the first joint auxiliary portion 235 are provided with joint housings 258 respectively, each of the joint housings 258 is formed with a circular snap-fit slot 259 in a circumferential direction of each of the joint housings 258, each of the two forearm connecting snap-fit portions 257 is snap-fitted with the circular snap-fit slot 259, the forearm upper housing 252 and the forearm snap-fit housing 254 are snap-fitted and secured, and the forearm upper housing 252 and the forearm lower housing 253 are securely connected by bolts so that the forearm upper housing 252, the forearm lower housing 253, and the forearm snap-fit housing 254 jointly form an enclosed forearm inner chamber. Moreover, the first forearm connecting rod 246, the second forearm connecting rod 247, the third forearm connecting rod 248, the forearm housing bracket 249, the fourth arm bearing 240, the fifth arm bearing 241, the fourth arm bearing seat 242, and the joint output shaft 243 are all located within the forearm inner chamber.

In some other embodiments, as shown in FIGS. 36 and 44, the fifth joint mechanism 190 further includes the fifth arm motor seat 251, an arm output frame 260, an arm wire-pressing buckle 261, and an arm wire-pressing housing 262. The fifth arm motor is securely mounted within the fifth arm motor seat 251. The arm output frame 260 is an L-shaped bracket structure, one end of a vertical portion 263 of the arm output frame 260 facing away from a horizontal portion 264 of the arm output frame 260 is securely connected to the output shaft of the fifth arm motor, and a sixth arm motor seat 265 of the sixth arm motor is securely disposed on the horizontal portion 264 of the arm output frame 260, thereby connecting the fifth joint mechanism 190 to the sixth joint mechanism 200 through the design of the arm output frame 260. Further, a motor seat end surface of the fifth arm motor seat 251 facing the output shaft of the fifth arm motor is provided with a sixth joint limiting block 266. When operating, the fifth arm motor drives the arm output frame 260 to rotate, and the sixth joint limiting block 266 blocks the vertical portion 263 of the arm output frame 260 to limit the rotation of the output shaft of the fifth arm motor, thereby avoiding the entanglement of the wire. Further, the arm wire-pressing buckle 261 is disposed on a motor tail cover of the fifth arm motor seat 251, and a wire of the sixth arm motor is pressed and limited by the arm wire-pressing buckle 261, penetrates through the arm wire-pressing buckle 261, and enters the forearm housing 250 of the robotic forearm structure 189. Moreover, the arm wire-pressing housing 262 is securely connected to the motor tail cover of the fifth arm motor seat 251 to cover the arm wire-pressing buckle 261 and to avoid external wiring so that the robotic arm 3 can be more aesthetically pleasing overall.

In addition, as shown in FIG. 44, the sixth joint mechanism 200 further includes the sixth arm motor seat 265 and a gripper securing seat 267. The sixth arm motor is securely mounted within the sixth arm motor seat 265; the sixth arm motor seat 265 is disposed on an end surface of the horizontal portion 264 of the arm output frame 260 facing the fifth arm motor seat 251, and the output shaft of the sixth arm motor penetrates through the horizontal portion 264 of the arm output frame 260 and is securely connected to the gripper securing seat 267, thereby securely mounting the gripper structure 4 onto the gripper securing seat 267.

In the embodiments of the present disclosure, as shown in FIGS. 45 to 50, the gripper structure 4 includes a gripper mounting seat 268, a gripper driving motor 269, a rotary-to-linear mechanism 276, and two fingers 300. The gripper mounting seat 268 is configured for the secure connection of the entire gripper structure 4 and the robotic arm 3. The gripper driving motor 269 serves as a driving member of the gripper structure 4 and drives the two fingers 300 to perform linear motions through the rotary-to-linear mechanism 276, thereby performing gripping and releasing actions. Specifically, the gripper structure 4 is securely mounted onto the robotic arm 3 through the gripper mounting seat 268; a motor tail cover end of the gripper driving motor 269 is securely mounted onto the gripper mounting seat 268; the rotary-to-linear mechanism 276 is securely connected to an output shaft 270 of the gripper driving motor 269, the two fingers 300 are connected to the rotary-to-linear mechanism 276, the rotary-to-linear mechanism 276 converts a rotary motion of the output shaft 270 of the gripper driving motor 269 into linear motions of the two fingers 300, and when operating, the gripper driving motor 269 drives the two fingers 300 to move away from each other to open or move toward each other to close through the rotary-to-linear mechanism 276 so that the gripper structure 4 performs the gripping and releasing through the two fingers 300.

In some embodiments, as shown in FIGS. 47 to 50, the rotary-to-linear mechanism 276 includes a grooved wheel 277, two pulley pins 281, a linear structure 282, two linear sliders 291, and two finger mounting members 295. The grooved wheel 277 is securely connected to the output shaft 270 of the gripper driving motor 269, and two rotary sliding grooves 278 are symmetrically formed on the grooved wheel 277. The two pulley pins 281 are disposed within the two rotary sliding grooves 278 respectively. The linear structure 282 is securely connected to a motor housing 273 of the gripper driving motor 269, and two linear sliding grooves are symmetrically formed on the linear structure 282. The two linear sliders 291 are disposed within the two linear sliding grooves respectively. Moreover, the grooved wheel 277 is located within a chamber between the linear structure 282 and the gripper driving motor 269, and the two pulley pins 281 disposed within the two rotary sliding grooves 278 are securely connected to end surfaces of the two linear sliders 291 respectively. As such, a rotary motion of the grooved wheel 277 is converted into a linear motion of the linear structure 282 through the pulley pins 281 and the linear sliders 291. The other end surfaces of the two linear sliders 291 are securely connected to the two fingers 300 through the two finger mounting members 295 respectively. When the gripper driving motor 269 operates, the output shaft 270 of the gripper driving motor 269 drives the grooved wheel 277 to perform the rotary motion to drive the two pulley pins 281 to slide within the two rotary sliding grooves 278 respectively and to drive the two linear sliders 291 to perform linear motions along the two linear sliding grooves respectively so that the two linear sliders 291 move toward or away from each other, and the two fingers 300 move away from each other to open or move toward each other to close through the two finger mounting members 295, thereby enabling the gripper structure 4 to grip and release an object. In the specific implementation, each pulley pin 281 is securely connected to a threaded hole at the bottom of a respective linear slider 291 through a screw of each pulley pin 281, and each pulley pin 281 is rotatable with an inherent bearing. Thus, each pulley pin 281 functions as a pulley and may rotate within a respective rotary sliding groove 278 and drive the respective linear slider 291 to move.

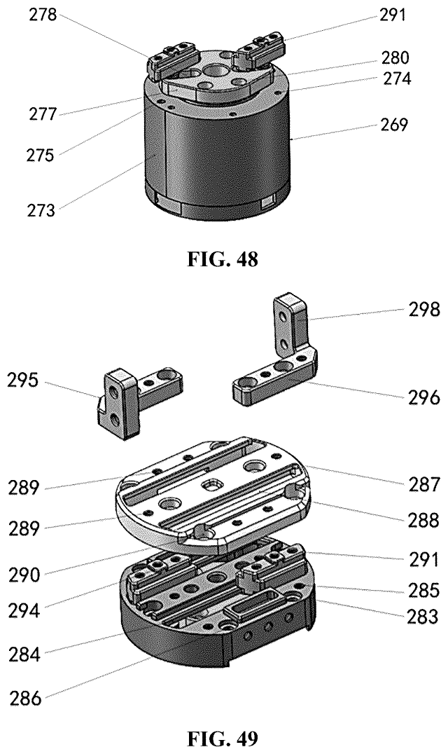

In some specific embodiments, as shown in FIGS. 47 and 48, the grooved wheel 277 is a plate-shaped structure. A middle portion of the grooved wheel 277 is securely connected to the output shaft 270 of the gripper driving motor 269 by bolts, and the two rotary sliding grooves 278 are symmetrically formed on an end surface of the grooved wheel 277 facing away from the gripper driving motor 269. Moreover, each rotary sliding groove 278 is a linear groove structure, and the diameter of the pulley pin 281 is adapted to the width of the rotary sliding groove 278, so as to ensure that the pulley pin 281 can move within the rotary sliding groove 278 along an extension direction of the rotary sliding groove 278. In addition, the middle portion of the grooved wheel 277 is a circular plate structure, with a diameter adapted to that of the output shaft 270 of the gripper driving motor 269, and is securely connected to an end surface of the output shaft 270 of the gripper driving motor 269 by bolts. Two end edges of the grooved wheel 277, where the two rotary sliding grooves 278 are formed, are straight edges, and the two end edges of the grooved wheel 277 are integrally and transitionally connected to the middle portion of the grooved wheel 277, that is, the grooved wheel 277 is a substantially elliptical plate structure. This ensures the stability of the secure mounting of the grooved wheel 277 while minimizing the overall structure of the grooved wheel 277.

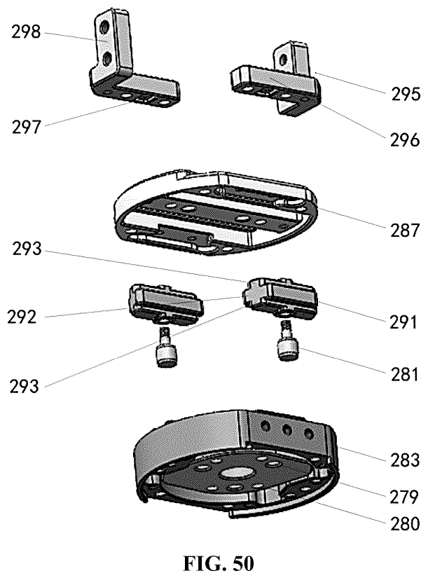

Further, as shown in FIGS. 47 and 50, multiple fourth mounting holes 272 are evenly and equidistantly spaced apart along a circumferential direction of the end surface of the output shaft 270 of the gripper driving motor 269. Correspondingly, the grooved wheel 277 is provided with multiple fifth mounting holes 280, that is, the multiple fifth mounting holes 280 are evenly and equidistantly spaced apart along a circumferential direction of the middle portion of the grooved wheel 277. The multiple fifth mounting holes 280 are in one-to-one correspondence with the multiple fourth mounting holes 272. The grooved wheel 277 is securely mounted onto the output shaft 270 of the gripper driving motor 269 by bolts that sequentially penetrate through the fifth mounting holes 280 and the fourth mounting holes 272. Further, the grooved wheel 277 is further provided with multiple third positioning through holes 279. Correspondingly, the end surface of the output shaft 270 of the gripper driving motor 269 is further provided with multiple second positioning groove holes 271, and the multiple second positioning groove holes 271 are in one-to-one correspondence with the multiple third positioning through holes 279. Through positioning pins that sequentially penetrate through the third positioning through holes 279 and the second positioning groove holes 271, a positioning connection is enabled between the grooved wheel 277 and the output shaft 270 of the gripper driving motor 269, and the assembly efficiency between the grooved wheel 277 and the output shaft 270 of the gripper driving motor 269 is improved.

In some other specific embodiments, as shown in FIGS. 47, 49, and 50, the linear structure 282 includes a linear sliding groove seat 283 and a linear sliding groove cover 287. The linear sliders 291 are disposed between the linear sliding groove seat 283 and the linear sliding groove cover 287 to be limited and secured. Moreover, the provision of the linear sliding groove seat 283 enables the grooved wheel 277 to be located between the linear structure 282 and the gripper driving motor 269 and to rotate with the rotation of the gripper driving motor 269. The linear sliding groove seat 283 is a housing structure with an opening at one end. An opening end of the linear sliding groove seat 283 is securely connected to the motor housing 273 of the gripper driving motor 269. A chamber is formed between the linear sliding groove seat 283 and the motor housing 273 for accommodating the grooved wheel 277, and the grooved wheel 277 is located within the housing of the linear sliding groove seat 283. Moreover, the linear sliding groove cover 287 is securely connected to an end surface of the linear sliding groove seat 283 facing away from the gripper driving motor 269. A space is reserved between the linear sliding groove cover 287 and the linear sliding groove seat 283 for disposing the linear sliders 291 and limiting the linear sliders 291. Specifically, two first linear sliding grooves 284 are formed on the end surface of the linear sliding groove seat 283, with each first linear sliding groove 284 penetrating through the inside and the outside of the housing of the linear sliding groove seat 283. Similarly, two second linear sliding grooves 288 are formed on the linear sliding groove cover 287, with each second linear sliding groove 288 penetrating through two opposite end surfaces of the linear sliding groove cover 287. The two second linear sliding grooves 288 are in one-to-one correspondence with the two first linear sliding grooves 284. When the linear sliding groove seat 283 and the linear sliding groove cover 287 are assembled and secured, the linear sliders 291 are sandwiched between the linear sliding groove seat 283 and the linear sliding groove cover 287, with two ends of each linear slider 291 respectively disposed in a respective first linear sliding groove 284 and a respective second linear sliding groove 288. As such, the respective first linear sliding groove 284 and the respective second linear sliding groove 288 jointly form a horizontal linear sliding groove, allowing each linear slider 291 to translate only. Moreover, the two linear sliders 291 move independently of each other.

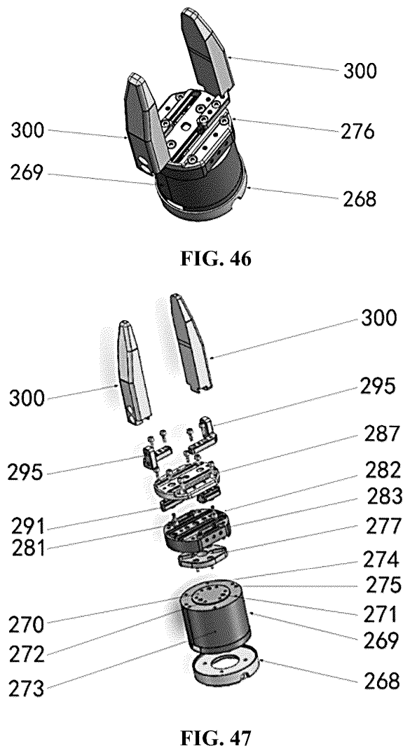

Further, as shown in FIGS. 46 and 49, the shape of the end surface of the linear sliding groove seat 283 is adapted to that of an end surface of the linear sliding groove cover 287 so that after assembly, outer surfaces of the linear sliding groove seat 283 and the linear sliding groove cover 287 coincide with each other, thereby making the gripper structure 4 more aesthetically pleasing. In addition, multiple first mounting holes 289 are provided at two opposite edges of the linear sliding groove cover 287. Correspondingly, multiple second mounting holes 285 are provided at two opposite edges of the linear sliding groove seat 283, and the multiple second mounting holes 285 are in one-to-one correspondence with the multiple first mounting holes 289. Moreover, multiple third mounting holes 274 are provided on the motor housing 273 of the gripper driving motor 269, and the multiple third mounting holes 274 are in one-to-one correspondence with the multiple second mounting holes 285. As such, the linear sliding groove cover 287, the linear sliding groove seat 283, and the motor housing 273 of the gripper driving motor 269 are securely connected by bolts that sequentially penetrate through the first mounting holes 289, the second mounting holes 285, and the third mounting holes 274, thereby reducing the total number of bolts required for the overall assembly of the gripper structure 4.

As shown in FIGS. 49 and 50, a vertical surface of each linear slider 291 is cross-shaped, a vertical surface of the respective first linear sliding groove 284 is inverted groove-shaped, and a vertical surface of the respective second linear sliding groove 288 is groove-shaped. Two ends of a large-diameter portion 292 of each linear slider 291 are disposed in a large-diameter portion of the respective first linear sliding groove 284 and a large-diameter portion of the respective second linear sliding groove 288 respectively, and two small-diameter portions 293 of each linear slider 291 are disposed in a small-diameter portion of the respective first linear sliding groove 284 and a small-diameter portion of the respective second linear sliding groove 288 respectively. Moreover, the small-diameter width of each linear slider 291 is adapted to the small-diameter width of the respective first linear sliding groove 284 and the small-diameter width of the respective second linear sliding groove 288, and the large-diameter width of each linear slider 291 is adapted to the large-diameter width of the respective first linear sliding groove 284 and the large-diameter width of the respective second linear sliding groove 288. As such, when the linear sliding groove cover 287 and the linear sliding groove seat 283 are assembled, the respective first linear sliding groove 284 and the respective second linear sliding groove 288 form a linear sliding groove structure that limits each cross-shaped linear slider 291.

As shown in FIGS. 47 to 50, multiple first positioning through holes 286 are provided on the linear sliding groove seat 283. Correspondingly, multiple second positioning through holes 290 are provided on the linear sliding groove cover 287, and the multiple second positioning through holes 290 are in one-to-one correspondence with the multiple first positioning through holes 286. Moreover, multiple first positioning groove holes 275 are provided on the motor housing 273 of the gripper driving motor 269, and the multiple first positioning groove holes 275 are in one-to-one correspondence with the multiple first positioning through holes 286. A positioning connection is enabled between the linear sliding groove cover 287, the linear sliding groove seat 283, and the motor housing 273 of the gripper driving motor 269 through positioning pins that sequentially penetrate through the second positioning through holes 290, the first positioning through holes 286, and the first positioning groove holes 275.

In some other embodiments, as shown in FIG. 49, each finger mounting member 295 includes a slider connecting portion 296 and a finger connecting portion 298 that are integrally formed. The slider connecting portion 296 is configured for the secure connection of each finger mounting member 295 and a respective linear slider 291, and the finger connecting portion 298 is configured for the secure connection of each finger mounting member 295 and a respective finger 300. Specifically, the slider connecting portion 296 and the finger connecting portion 298 are each a rectangular block structure. The slider connecting portion 296 extends along a respective linear sliding groove and is securely connected to an end surface of the respective linear slider 291 facing away from the linear structure 282 by bolts. Moreover, the finger connecting portion 298 is perpendicularly connected to one end of the slider connecting portion 296, and the respective finger 300 is securely connected to an inner end surface of the finger connecting portion 298 by bolts. Each finger mounting member 295 securely connects the respective finger 300 to the respective linear slider 291, allowing the respective finger 300 to perform a linear motion together with the respective linear slider 291. Moreover, the provision of each finger mounting member 295 securely connects the respective finger 300 to the rotary-to-linear mechanism 276, enabling the respective finger 300 to be easily replaced with a new finger 300 of a corresponding model as needed and thereby enhancing practicality. Further, a middle portion of the end surface of the respective linear slider 291 facing away from the linear structure 282 is provided with a gripper positioning block 294 that is a rectangular block structure. Correspondingly, an end surface of the slider connecting portion 296 facing the respective linear slider 291 is formed with a slider positioning groove 297 corresponding to the gripper positioning block 294. The shape of the slider positioning groove 297 is the same as that of the gripper positioning block 294. As such, the gripper positioning block 294 is snap-fitted into the slider positioning groove 297 to enable a positioning connection between the respective linear slider 291 and each finger mounting member 295.

When the gripper driving motor 269 operates, the output shaft 270 of the gripper driving motor 269 drives the grooved wheel 277 to rotate. Since the pulley pins 281 are embedded into the rotary sliding grooves 278 of the grooved wheel 277, as the grooved wheel 277 rotates, the pulley pins 281 slide within the rotary sliding grooves 278 to drive the linear sliders 291 to move. Since the linear sliders 291 are constrained by the linear sliding groove seat 283 and the linear sliding groove cover 287, the linear sliders 291 can perform the linear motions only to drive the finger mounting members 295 and the fingers 300 on the finger mounting members 295 to perform linear motions. As such, the rotary motion of the gripper driving motor 269 is converted into the opposite opening and closing motions of the two fingers.

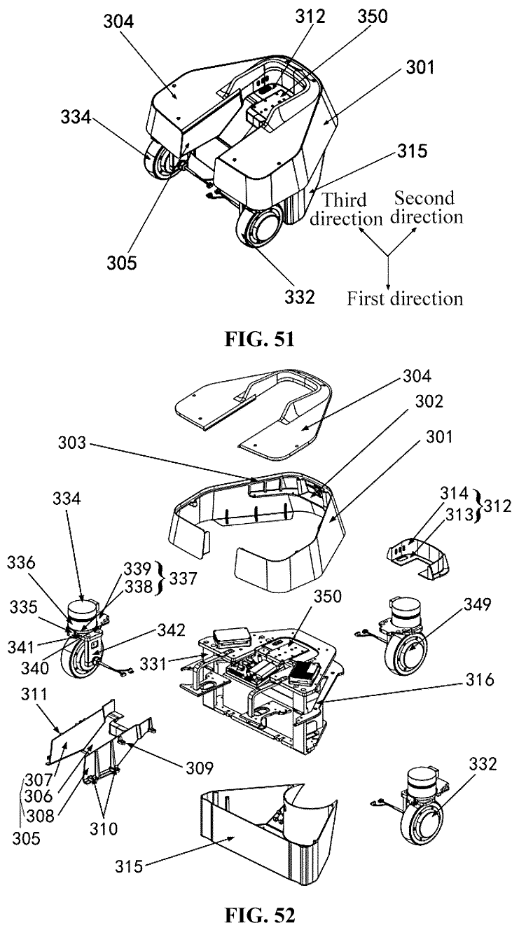

In the embodiments of the present disclosure, as shown in FIGS. 51 to 54, the chassis driving structure 5 includes a chassis middle housing 301, a chassis upper housing 304, a chassis middle front housing 305, a chassis middle rear housing 312, a chassis lower housing 315, a chassis skeleton assembly 316, a front left steering wheel assembly 332, a front right steering wheel assembly 334, and a rear steering wheel assembly 349. The chassis middle housing 301, the chassis upper housing 304, the chassis middle front housing 305, the chassis middle rear housing 312, and the chassis lower housing 315 jointly form the housing structure of the chassis driving structure 5. The chassis skeleton assembly 316 serves as a main internal support structure of the chassis driving structure 5. The chassis middle housing 301, the chassis middle front housing 305, the chassis middle rear housing 312, and the chassis lower housing 315 are all mounted onto the chassis skeleton assembly 316. The front left steering wheel assembly 332, the front right steering wheel assembly 334, and the rear steering wheel assembly 349 function as mobile driving units of the chassis driving structure 5. These three assemblies form a triangular stable structure mounted below the housing structure to enable steering and movement of the chassis driving structure 5.

Specifically, as shown in FIG. 52, the chassis middle housing 301 is a housing structure that has two opening ends along the first direction and has a wide end and a narrow end along the second direction, wherein the narrow end is narrower than the wide end, and the wide end is provided with an opening along the second direction. The chassis upper housing 304 is mounted at one of opening ends of the chassis middle housing 301, a middle portion of the chassis upper housing 304 is provided with a notch along the second direction, and an opening end of the notch faces the wide end. The notch is formed by the opening end and a non-opening end. One end of the chassis middle front housing 305 along the first direction is mounted at the opening end of the notch, and one end of the chassis middle front housing 305 along the second direction is mounted at an opening end of the wide end. One end of the chassis middle rear housing 312 along the second direction is mounted at the non-opening end of the notch. The chassis lower housing 315 is mounted at the other one of the opening ends of the chassis middle housing 301. As such, the chassis middle housing 301, the chassis upper housing 304, the chassis middle front housing 305, the chassis middle rear housing 312, and the chassis lower housing 315 are assembled to form an enclosed chamber. In the embodiments of the present disclosure, the chamber is not completely enclosed. The chamber is left open to allow the three steering wheel assemblies to be mounted onto the chassis skeleton assembly 316, as detailed below.

With continued reference to FIGS. 51 and 52, one side surface of the chassis skeleton assembly 316 facing the chassis upper housing 304 along the first direction is provided with a rectangular protrusion 350, one end of the rectangular protrusion 350 along the second direction abuts against and is secured to the other end of the chassis middle front housing 305 along the second direction, and the other end of the rectangular protrusion 350 along the second direction abuts against and is secured to the other end of the chassis middle rear housing 312 along the second direction. All the portions of the chassis skeleton assembly 316 other than the rectangular protrusion 350 are disposed within the chamber, and the chassis middle housing 301, the chassis middle front housing 305, the chassis middle rear housing 312, and the chassis lower housing 315 are all mounted onto the chassis skeleton assembly 316. In the torso structure 1, a motor bearing seat of the lower leg assembly 6 is securely mounted onto the rectangular protrusion 350.

With continued reference to FIGS. 51 and 52, one end of the front left steering wheel assembly 332 is located within the chamber and is securely connected to one end of the chassis skeleton assembly 316 along the third direction, and the other end of the front left steering wheel assembly 332 is located outside the chamber; one end of the front right steering wheel assembly 334 is located within the chamber and is securely connected to the other end of the chassis skeleton assembly 316 along the third direction, and the other end of the front right steering wheel assembly 334 is located outside the chamber; one end of the rear steering wheel assembly 349 is located within the chamber and is securely connected to one end of the chassis skeleton assembly 316 facing away from the wide end along the second direction, and the other end of the rear steering wheel assembly 349 is located outside the chamber; the front left steering wheel assembly 332, the front right steering wheel assembly 334, and the rear steering wheel assembly 349 are located at three vertices of a triangle, thereby ensuring that the three steering wheel assemblies can stably contact the ground simultaneously while maintaining flexible mobility.

In conclusion, the chassis driving structure 5 provided in the embodiments of the present disclosure includes the chassis middle housing 301, the chassis upper housing 304, the chassis middle front housing 305, the chassis middle rear housing 312, the chassis lower housing 315, the chassis skeleton assembly 316, the front left steering wheel assembly 332, the front right steering wheel assembly 334, and the rear steering wheel assembly 349. The chassis middle housing 301 is the housing structure having the openings at the two ends along the first direction and being narrow at the end and wide at the other end along the second direction, and the wide end of the chassis middle housing 301 along the second direction is provided with the opening. The chassis upper housing 304 is mounted at the one of the opening ends of the chassis middle housing 301, the middle portion of the chassis upper housing 304 is provided with the notch along the second direction, and the opening end of the notch faces the wide end. The end of the chassis middle front housing 305 along the first direction is mounted at the opening end of the notch, and the end of the chassis middle front housing 305 along the second direction is mounted at the opening end of the wide end. The end of the chassis middle rear housing 312 along the second direction is mounted at the non-opening end of the notch. The chassis lower housing 315 is mounted at the other one of the opening ends of the chassis middle housing, and the chassis middle housing 301, the chassis upper housing 304, the chassis middle front housing 305, the chassis middle rear housing 312, and the chassis lower housing 315 are assembled to form the enclosed chamber. The side surface of the chassis skeleton assembly 316 facing the chassis upper housing 304 along the first direction is provided with the rectangular protrusion 350, the end of the rectangular protrusion 350 along the second direction abuts against and is secured to the other end of the chassis middle front housing 305 along the second direction, and the other end of the rectangular protrusion 350 along the second direction abuts against and is secured to the other end of the chassis middle rear housing 312 along the second direction. All the portions of the chassis skeleton assembly 316 other than the rectangular protrusion 350 are disposed within the chamber, and the chassis middle housing 301, the chassis middle front housing 305, the chassis middle rear housing 312, and the chassis lower housing 315 are all mounted onto the chassis skeleton assembly 316. The end of the front left steering wheel assembly 332 is located within the chamber and is securely connected to the end of the chassis skeleton assembly 316 along the third direction, and the other end of the front left steering wheel assembly 332 is located outside the chamber. The end of the front right steering wheel assembly 334 is located within the chamber and is securely connected to the other end of the chassis skeleton assembly 316 along the third direction, and the other end of the front right steering wheel assembly 334 is located outside the chamber. The end of the rear steering wheel assembly 349 is located within the chamber and is securely connected to the end of the chassis skeleton assembly 316 facing away from the wide end along the second direction, and the other end of the rear steering wheel assembly 349 is located outside the chamber. The front left steering wheel assembly 332, the front right steering wheel assembly 334, and the rear steering wheel assembly 349 are located at three vertices of a triangle. The first direction, the second direction, and the third direction are perpendicular to one another. Since the chassis middle housing 301 is the housing structure being narrow at the end and wide at the other end along the second direction, the entire chassis driving structure 5 forms a compact structure similar to a triangle. Moreover, since the chassis upper housing 304 is mounted onto the chassis middle housing 301, and the chassis middle housing 301, the chassis middle front housing 305, the chassis middle rear housing 312, and the chassis lower housing 315 are all mounted onto the chassis skeleton assembly 316, during testing, maintenance and inspection can be performed simply by accessing the internal structure by removing the chassis upper housing 304 from the chassis middle housing 301 and then detaching the chassis middle housing 301, the chassis middle front housing 305, and the chassis middle rear housing 312 from the chassis skeleton assembly 316. Therefore, the chassis driving structure 5 provided in the embodiments of the present disclosure features a compact structure and convenient disassembly, which facilitates the maintenance and inspection during testing and greatly improves the maintenance efficiency.

With continued reference to FIGS. 52 to 54, the chassis skeleton assembly 316 provided in the embodiments of the present disclosure includes a chassis skeleton upper panel 317, a chassis skeleton middle panel 318, a chassis skeleton lower panel 326, a left middle-panel support frame 327, a right middle-panel support frame 328, a panel rear support plate 329, a panel left support plate 330, and a panel right support plate 331. The chassis skeleton upper panel 317, the chassis skeleton middle panel 318, and the chassis skeleton lower panel 326 are sequentially disposed along the first direction. With continued reference to FIG. 52, the inner wall of the narrow end of the chassis middle housing 301 is provided with an upper panel mounting frame 302. The chassis skeleton upper panel 317 may be mounted onto the upper panel mounting frame 302 by screws. As such, the chassis skeleton upper panel 317 is mounted onto the chassis middle housing 301 in a manner in which the inner wall of the narrow end of the chassis middle housing 301 is provided with the upper panel mounting frame 302.

With continued reference to FIG. 52, the chassis upper housing 304 may be mounted onto the one of the opening ends of the chassis middle housing 301 in a manner in which one side surface of the chassis upper housing 304 along the first direction may be mounted onto the chassis skeleton upper panel 317 by screws.

With continued reference to FIG. 52, the chassis lower housing 315 is a housing structure with an opening at one end along the first direction, and the chassis skeleton middle panel 318 is mounted at an opening end of the chassis lower housing 315. A specific mounting manner may be as follows: the chassis skeleton middle panel 318 is provided with multiple first threaded holes, the housing structure of the opening end of the chassis lower housing 315 is correspondingly provided with multiple mounting posts, each mounting post is internally threaded, and the chassis skeleton middle panel 318 is connected to the chassis lower housing 315 through the first threaded holes and the mounting posts using screws. Exemplarily, at least two first threaded holes are provided. As such, the chassis lower housing 315 is mounted onto the chassis skeleton assembly 316 in a manner in which the chassis skeleton middle panel 318 is mounted at the opening end of the chassis lower housing 315.

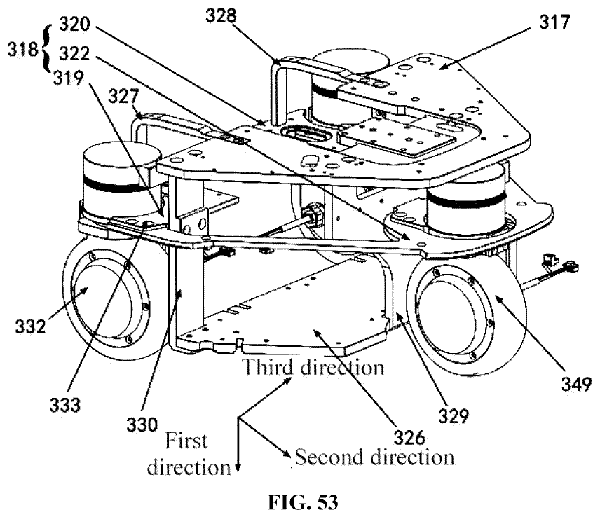

With continued reference to FIGS. 52 and 53, one end of the panel rear support plate 329, one end of the panel left support plate 330, and one end of the panel right support plate 331 are all mounted onto the chassis skeleton upper panel 317, and the other end of the panel rear support plate 329, the other end of the panel left support plate 330, and the other end of the panel right support plate 331 are mounted onto the chassis skeleton lower panel 326, so as to support these three chassis skeleton panels. Specifically, the panel rear support plate 329 extends along the first direction and is located adjacent to the rear steering wheel assembly 349, and two ends of the panel rear support plate 329 along the first direction are connected to the chassis skeleton upper panel 317 and the chassis skeleton lower panel 326 respectively; the panel left support plate 330 extends along the first direction and is located adjacent to the front left steering wheel assembly 332, and two ends of the panel left support plate 330 along the first direction are connected to the chassis skeleton upper panel 317 and the chassis skeleton lower panel 326 respectively; the panel right support plate 331 extends along the first direction and is located adjacent to the front right steering wheel assembly 334, and two ends of the panel right support plate 331 along the first direction are connected to the chassis skeleton upper panel 317 and the chassis skeleton lower panel 326 respectively, where the connections may be enabled by screws.

With continued reference to FIG. 53, the chassis skeleton middle panel 318 includes a front left steering wheel assembly mounting plate 319, a front right steering wheel assembly mounting plate 320, and a rear steering wheel assembly mounting plate 322; one end of the left middle-panel support frame 327 is securely mounted onto one side surface of the chassis skeleton upper panel 317 facing the front left steering wheel assembly 332, and the other end of the left middle-panel support frame 327 is securely mounted onto the front left steering wheel assembly mounting plate 319; one end of the right middle-panel support frame 328 is securely mounted onto one side surface of the chassis skeleton upper panel 317 facing the front right steering wheel assembly 334, and the other end of the right middle-panel support frame 328 is securely mounted onto the front right steering wheel assembly mounting plate 320, where the connections may be enabled by screws. In other words, the front left steering wheel assembly mounting plate 319 is mounted onto the chassis skeleton upper panel 317 through the left middle-panel support frame 327, and the front right steering wheel assembly mounting plate 320 is mounted onto the chassis skeleton upper panel 317 through the right middle-panel support frame 328. The specific forms of the left middle-panel support frame 327 and the right middle-panel support frame 328 may be configured according to actual requirements. In the embodiments of the present disclosure, both the left middle-panel support frame 327 and the right middle-panel support frame 328 are L-shaped support frames.

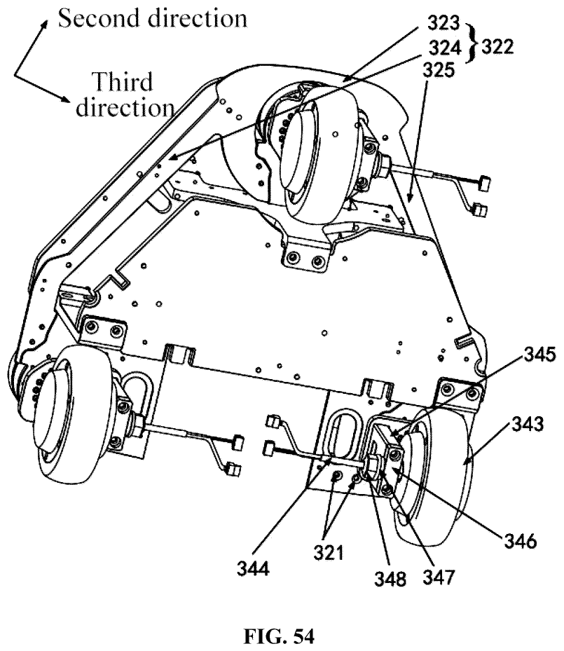

With continued reference to FIGS. 53 and 54, one end of the rear steering wheel assembly mounting plate 322 facing the rear steering wheel assembly 349 along the second direction is securely mounted onto the panel rear support plate 329, and two ends of the rear steering wheel assembly mounting plate 322 along the third direction are connected to the front left steering wheel assembly 332 and the front right steering wheel assembly 334 respectively. The connections may be enabled by screws.

With continued reference to FIG. 54, the specific form of the rear steering wheel assembly mounting plate 322 may be configured according to the actual requirements. In the embodiments of the present disclosure, the rear steering wheel assembly mounting plate 322 is a symmetrical structure. The rear steering wheel assembly mounting plate 322 includes a steering wheel mounting plate 323, and a left bracket 324 and a right bracket 325 that extend from two sides of the steering wheel mounting plate 323 toward the front left steering wheel assembly 332 and the front right steering wheel assembly 334 respectively. One end of the steering wheel mounting plate 323 along the second direction is mounted onto the panel rear support plate 329, the left bracket 324 is mounted onto the front left steering wheel assembly 332, and the right bracket 325 is mounted onto the front right steering wheel assembly 334. The rear steering wheel assembly 349 is mounted onto the steering wheel mounting plate 323. The mounting manners may be enabled by screws. As such, these three chassis skeleton panels are supported in a manner in which the end of the panel rear support plate 329, the end of the panel left support plate 330, and the end of the panel right support plate 331 are all mounted onto the chassis skeleton upper panel 317, and the other end of the panel rear support plate 329, the other end of the panel left support plate 330, and the other end of the panel right support plate 331 are mounted onto the chassis skeleton lower panel 326; the end of the rear steering wheel assembly mounting plate 322 facing the rear steering wheel assembly 349 along the second direction is securely mounted onto the panel rear support plate 329. In addition, the front left steering wheel assembly mounting plate 319 is mounted onto the chassis skeleton upper panel 317 through the left middle-panel support frame 327, and the front right steering wheel assembly mounting plate 320 is mounted onto the chassis skeleton upper panel 317 through the right middle-panel support frame 328.

With continued reference to FIG. 52, a narrow end of the chassis middle housing 301 facing the chassis upper housing 304 is mounted onto the chassis skeleton upper panel 317. Specifically, the edge of the narrow end of the chassis middle housing 301 facing the chassis upper housing 304 is provided with a mounting strip 303. The mounting strip 303 is provided with multiple second threaded holes, and the chassis skeleton upper panel 317 is provided with multiple third threaded holes in one-to-one correspondence with the second threaded holes. The mounting strip 303 is connected to the chassis skeleton upper panel 317 through the second threaded holes and the third threaded holes using screws. Four second threaded holes and four third threaded holes are provided. A wide end of the chassis middle housing 301 facing the chassis upper housing 304 is mounted onto the chassis middle front housing 305. Specifically, the inner wall of the wide end of the chassis middle housing 301 facing the chassis upper housing 304 is provided with two fourth threaded holes, and the inner wall of the chassis middle front housing 305 is provided with two fifth threaded holes 311 in one-to-one correspondence with the two fourth threaded holes. The wide end of the chassis middle housing 301 facing the chassis upper housing 304 is connected to the chassis middle front housing 305 through the fourth threaded holes and the fifth threaded holes using screws.

With continued reference to FIGS. 52 to 54, two sides of an opening at a wide end of the chassis middle housing 301 facing away from the chassis upper housing 304 are connected to the front left steering wheel assembly mounting plate 319 and the front right steering wheel assembly mounting plate 320 respectively. Specifically, two sixth threaded holes and two seventh threaded holes are provided on the housings of the two sides of the opening at the wide end of the chassis middle housing 301 facing away from the chassis upper housing 304 respectively. The front left steering wheel assembly mounting plate 319 is provided with two eighth threaded holes in one-to-one correspondence with the two sixth threaded holes, and the front right steering wheel assembly mounting plate 320 is provided with two ninth threaded holes 321 in one-to-one correspondence with the two seventh threaded holes. The housings of the two sides of the opening at the wide end of the chassis middle housing 301 facing away from the chassis upper housing 304 is connected to the front left steering wheel assembly mounting plate 319 through the sixth threaded holes and the eighth threaded holes using bolts and is connected to the front right steering wheel assembly mounting plate 320 through the seventh threaded holes and the ninth threaded holes 321 using bolts, respectively. As such, the chassis middle housing 301 is connected to the chassis middle front housing 305, the front left steering wheel assembly mounting plate 319, and the front right steering wheel assembly mounting plate 320 in a manner in which the narrow end of the chassis middle housing 301 facing the chassis upper housing 304 is mounted onto the chassis skeleton upper panel 317, the wide end of the chassis middle housing 301 facing the chassis upper housing 304 is mounted onto the chassis middle front housing 305, and the two sides of the opening at the wide end of the chassis middle housing 301 facing away from the chassis upper housing 304 are connected to the front left steering wheel assembly mounting plate 319 and the front right steering wheel assembly mounting plate 320 respectively.

With continued reference to FIG. 52, the chassis middle rear housing 312 includes a gate-shaped bottom plate 313 and an outer support plate 314 extending along the first direction from the outer edge of the gate-shaped bottom plate. One side surface of the gate-shaped bottom plate 313 along the first direction is securely mounted onto the chassis skeleton upper panel 317. The inner edge of the gate-shaped bottom plate 313 abuts against and is secured to the other end of the rectangular protrusion 350 along the second direction, and the outer edge of the outer support plate 314 facing the chassis upper housing 304 abuts against and is secured to the housing structure at the non-opening end of the chassis upper housing 304. As such, the chassis middle rear housing 312 is mounted onto the chassis skeleton upper panel 317 in a manner in which the side surface of the gate-shaped bottom plate 313 along the first direction is securely mounted onto the chassis skeleton upper panel 317, the inner edge of the gate-shaped bottom plate 313 abuts against and is secured to the other end of the rectangular protrusion 350 along the second direction, and the outer edge of the outer support plate 314 facing the chassis upper housing 304 abuts against and is secured to the housing structure at the non-opening end of the chassis upper housing 304.

With continued reference to FIG. 52, in the case where the chassis middle rear housing 312 includes the gate-shaped bottom plate 313 and the outer support plate 314 extending along the first direction from the outer edge of the gate-shaped bottom plate, the chassis middle front housing 305 includes a sloped securing plate 306 with a certain slope, a right support plate 307, and a left support plate 308. Two ends of the sloped securing plate 306 along the third direction are connected to the right support plate 307 and the left support plate 308 respectively, and both the left support plate 308 and the right support plate 307 extend along the second direction. The sloped securing plate 306 is a panel with a certain slope. The provision of a certain slope is to have a torso of the robot accommodated when the torso of the robot is bent. The slope of the sloped securing plate 306 needs to be determined according to the actual requirements. As such, by providing the sloped securing plate 306 with a certain slope, the torso of the robot can be accommodated when being bent. One end of the left support plate 308 along the first direction is mounted onto the chassis skeleton upper panel 317, and the other end of the left support plate 308 along the first direction is mounted onto the front left steering wheel assembly mounting plate 319. Specifically, the end of the left support plate 308 along the first direction is provided with at least two tenth threaded holes 309, and the chassis skeleton upper panel 317 is provided with at least two eleventh threaded holes in one-to-one correspondence with the at least two tenth threaded holes 309. The end of the left support plate 308 along the first direction is connected to the chassis skeleton upper panel 317 through the tenth threaded holes 309 and the eleventh threaded holes using bolts. The other end of the left support plate 308 along the first direction is provided with two twelfth threaded holes 310, and the front left steering wheel assembly mounting plate 319 is provided with two thirteenth threaded holes in one-to-one correspondence with the two twelfth threaded holes 310. The other end of the left support plate 308 along the first direction is connected to the front left steering wheel assembly mounting plate 319 through the twelfth threaded holes 310 and the thirteenth threaded holes using bolts. One end of the right support plate 307 along the first direction is mounted onto the chassis skeleton upper panel 317, and the other end of the right support plate 307 along the first direction is mounted onto the front right steering wheel assembly mounting plate 320. The right support plate 307 has the same mounting manner as the left support plate 308. For details, reference is made to the relevant description of the left support plate 308, which is not repeated herein.

With continued reference to FIG. 52, an uphill end of the sloped securing plate 306 is provided with a rectangular notch, and the rectangular notch abuts against and is secured to the end of the rectangular protrusion 350 along the second direction. Two sides of the rectangular notch at the uphill end abut against and are secured to the gate-shaped bottom plate 313, and a downhill end of the sloped securing plate 306 abuts against and is secured to the chassis lower housing 315. One end of the left support plate 308 along the second direction abuts against and is secured to the outer support plate 314, and the other end of the left support plate 308 along the second direction extends beyond the sloped securing plate 306 and abuts against and is secured to the housing structure on one side of the opening end of the wide end of the chassis middle housing 301. One end of the right support plate 307 along the second direction abuts against and is secured to the outer support plate 314, and the other end of the right support plate 307 along the second direction extends beyond the sloped securing plate 306 and abuts against and is secured to the housing structure of the other side at the opening end of the wide end of the chassis middle housing 301.

With continued reference to FIGS. 52 and 54, each steering wheel assembly has the same structure. Using the front right steering wheel assembly 334 as an example, the front right steering wheel assembly 334 includes a limiting block 335, a steering motor 336, a steering motor support plate 337, a hub motor support plate 341, and a hub motor assembly 342. The steering motor 336, the steering motor support plate 337, the hub motor support plate 341, and the hub motor assembly 342 are sequentially disposed along the first direction. An end portion of one side of the steering motor support plate 337 along the second direction is mounted onto a stator of the steering motor 336, and an end portion of the other side of the steering motor support plate 337 along the second direction is mounted onto a corresponding panel support plate that is referred to as the panel right support plate 331 herein, where the connections may be enabled by screws. As such, each steering wheel assembly is connected to the corresponding panel support plate through a respective steering motor support plate 337 using bolts so that each steering wheel assembly has a standardized threaded mounting opening, thereby facilitating replacement and maintenance. The hub motor support plate 341 is mounted onto a rotor of the steering motor 336, and the hub motor assembly 342 is mounted onto the hub motor support plate 341. The limiting block 335 is mounted at an end portion of the hub motor support plate 341 facing the stator along the second direction. The steering motor support plate 337 restricts the rotary range of the limiting block 335. The connections may be enabled by screws. During operation, the steering motor 336 drives the rotor to rotate, and the rotor drives the hub motor assembly 342 to rotate through the hub motor support plate 341, while the steering motor support plate 337 restricts the rotary range of the limiting block 335. Specifically, the steering motor support plate 337 includes a stator securing ring 338 and a limiting plate 339 that are disposed sequentially along the second direction. The stator securing ring 338 is mounted onto the stator, and two limiting portions 340 respectively extend outward along the second direction from two sides of the junction at which the limiting plate 339 is connected to the stator securing ring 338. When the limiting block 335 rotates with the steering motor 336 to reach a first limiting position, the limiting block 335 abuts against one of the two limiting portions 340; when the limiting block 335 rotates with the steering motor 336 to reach a second limiting position, the limiting block 335 abuts against the other one of the two limiting portions 340. Thus, the limiting block 335 serves to restrict the rotary range of the hub motor assembly 342 to prevent an excessively large rotary range of the hub motor assembly 342 from breaking a wire harness of a hub motor. Moreover, each steering wheel assembly fulfills the limiting function through the respective steering motor support plate 337 and a respective limiting block 335, without requiring an external structure for limiting and without sacrificing an external space for mounting the limiting structure, thereby making the limiting structure simple and compact.

With continued reference to FIGS. 52 and 54, the hub motor assembly 342 includes the hub motor 343, a hub motor cover plate 345, a hub motor base 346, a spacer 347, and a nut 348. One end of the hub motor cover plate 345 along the first direction is securely mounted onto the hub motor support plate 341, and the other end of the hub motor cover plate 345 along the first direction is securely mounted onto the hub motor base 346. The secure mounting manners may be enabled by screws. Moreover, the other end of the hub motor cover plate 345 along the first direction is provided with a first hub motor output shaft mounting notch. The secure mounting manners may be enabled by screws. One end of the hub motor base 346 facing the hub motor cover plate 345 along the first direction is provided with a second hub motor output shaft mounting notch. A hub motor output shaft mounting hole formed by the first hub motor output shaft mounting notch and the second hub motor output shaft mounting notch clamps an output shaft 344 of the hub motor 343. The spacer 347 is sleeved around the outer circumference of the output shaft 344, and the nut 348 is tightened onto the output shaft 344 to press the spacer 347 against the hub motor cover plate 345. The hub motor 343 may rotate around the output shaft 344. As such, in a manner in which the spacer 347 is sleeved around the outer circumference of the output shaft 344, and the nut 348 is tightened onto the output shaft 344 to press the spacer 347 against the hub motor cover plate 345, the hub motor 343 is mounted onto the hub motor cover plate 345 so that the hub motor support plate 341 can drive the hub motor 343 to rotate through the hub motor cover plate 345. As such, each steering wheel assembly can be provided with steering power through a respective steering motor 336 to achieve its rotation, and can be provided with driving power through a respective hub motor 343 to achieve its movement. Each steering wheel assembly can enable both steering and movement through the cooperation of the respective steering motor 336 and the respective hub motor 343.

With continued reference to FIGS. 52 to 54, one end of a steering motor support plate of the front left steering wheel assembly 332 along the third direction is mounted onto the front left steering wheel assembly mounting plate 319, and the other end of the steering motor support plate of the front left steering wheel assembly 332 along the third direction is mounted onto one end of the rear steering wheel assembly mounting plate 322 facing the panel left support plate 330. Specifically, the end of the steering motor support plate of the front left steering wheel assembly 332 along the third direction is provided with two fourteenth threaded holes, and the front left steering wheel assembly mounting plate 319 is provided with two fifteenth threaded holes in one-to-one correspondence with the two fourteenth threaded holes. The end of the steering motor support plate of the front left steering wheel assembly 332 along the third direction is connected to the front left steering wheel assembly mounting plate 319 through the fourteenth threaded holes and the fifteenth threaded holes using bolts. The other end of the steering motor support plate of the front left steering wheel assembly 332 along the third direction is provided with two sixteenth threaded holes 333, and the end of the rear steering wheel assembly mounting plate 322 facing the panel left support plate 330 is provided with two seventeenth threaded holes in one-to-one correspondence with the two sixteenth threaded holes 333. The other end of the steering motor support plate of the front left steering wheel assembly 332 along the third direction is connected to the end of the rear steering wheel assembly mounting plate 322 facing the panel left support plate 330 through the sixteenth threaded holes 333 and the seventeenth threaded holes using bolts. One end of the steering motor support plate of the front right steering wheel assembly 334 along the third direction is mounted onto the front right steering wheel assembly mounting plate 320, and the other end of the steering motor support plate of the front right steering wheel assembly 334 along the third direction is mounted onto one end of the rear steering wheel assembly mounting plate 322 facing the panel right support plate 331. A steering motor support plate of the rear steering wheel assembly 349 is mounted onto one end of the rear steering wheel assembly mounting plate 322 facing the panel rear support plate 329. The steering motor support plate of the front right steering wheel assembly 334 and the steering motor support plate of the rear steering wheel assembly 349 have the same mounting manner as the steering motor support plate of the front left steering wheel assembly 332. For details, reference is made to the relevant description of the steering motor support plate of the front left steering wheel assembly 332, which is not repeated herein. As such, the three steering wheel assemblies are mounted onto the chassis skeleton assembly 316 through the three steering motor support plates respectively. Since each steering wheel assembly can be provided with both steering power and driving power, the three steering wheel assemblies can enable the chassis driving structure 5 to perform steering and flexible movement.

It is to be noted that, in the present disclosure, the bearing models and the structural sizes of the various components may be correspondingly selected and set according to the overall structural stability and strength of the robot, so as to ensure the overall structural stability of the robot and the structural stability of the robot during movement. No limitation is imposed in this regard.

In conclusion, the present disclosure provides the robot. The torso structure has multiple degrees of freedom and can flexibly control the motions of the joints to perform different actions. Moreover, the torso structure of the robot is relatively lightweight and cost-effective. In addition, the torso structure of the robot adopts the internal wiring within the housing, which makes the overall structure more aesthetically pleasing. The head structure features a compact overall design and is easy to disassemble, facilitating maintenance and inspection during testing and thereby significantly improving the maintenance efficiency. Through the arrangement of the multiple joint mechanisms together with an upper arm and a forearm, the robotic arm can rotate in multiple degrees of freedom, and a tail end of the robotic arm can be lighter, thereby increasing the payload at the tail end. The gripper structure converts the rotary motion of a motor into the linear motion, which makes the gripper structure have a high torque with a minimized volume and have high reliability. In addition, the chassis structure of the entire robot forms a compact configuration similar to a triangle. The chassis upper housing is mounted onto the chassis middle housing, and the chassis middle housing, the chassis middle front housing, the chassis middle rear housing, and the chassis lower housing are all mounted onto the chassis skeleton assembly. Therefore, during testing, maintenance and inspection can be performed simply by accessing the internal structure by removing the chassis upper housing from the chassis middle housing and detaching the chassis middle housing, the chassis middle front housing, and the chassis middle rear housing from the chassis skeleton assembly. The chassis structure has an overall compact design with convenient disassembly, thereby facilitating the maintenance and inspection during testing and significantly improving the maintenance efficiency.

It is to be understood by those of ordinary skill in the art that the drawings are schematic illustrations of one embodiment, and the components shown therein are not necessarily essential to the implementation of the present disclosure. It is to be noted that similar reference numerals and letters represent similar components in the drawings. Therefore, once a component is defined in one drawing, the component no longer needs to be defined and interpreted in the subsequent drawings.

In the description of the embodiments of the present disclosure, unless otherwise expressly specified and limited, terms like “mounted”, “connected to each other”, and “connected” are to be construed in a broad sense, for example, as securely connected, detachably connected, or integratedly connected; mechanically connected or electrically connected; directly connected or indirectly connected via an intermediate medium; or internally connected between two elements. For those of ordinary skill in the art, specific meanings of the preceding terms in the present disclosure may be understood based on specific situations. In addition, in the description of the embodiments of the present disclosure, it is to be noted that orientations or position relations indicated by terms such as “center”, “upper”, “lower”, “left”, “right”, “vertical”, “horizontal”, “in” and “out” are based on the drawings. These orientations or position relations are intended only to facilitate and simplify the description of the present disclosure and not to indicate or imply that a referred apparatus or element must have such particular orientations or must be configured or operated in such particular orientations. Thus, these orientations or position relations are not to be construed as limiting the present disclosure.

What is claimed is:

1. A robot, comprising a torso structure, a head structure, robotic arms, gripper structures, and a chassis driving structure,
wherein the torso structure comprises a lower leg assembly, a thigh assembly, and a thoracic cavity assembly, wherein the lower leg assembly comprises a first torso motor, the lower leg assembly is rotatably connected to a robotic chassis structure through the first torso motor, and when the first torso motor operates, the first torso motor is configured to drive the lower leg assembly to rotate relative to the robotic chassis structure around an output shaft of the first torso motor within a plane formed by a first direction and a second direction; the thigh assembly comprises a second torso motor, the thigh assembly is rotatably connected to the lower leg assembly through the second torso motor, and when the second torso motor operates, the second torso motor is configured to drive the thigh assembly to rotate relative to the lower leg assembly around an output shaft of the second torso motor within the plane formed by the first direction and the second direction; the thoracic cavity assembly comprises a third torso motor, a third torso motor seat, a fourth torso motor, and a fourth torso motor seat, the third torso motor is disposed within the third torso motor seat, and an output shaft of the third torso motor is rotatably connected to the thigh assembly; the fourth torso motor seat is securely connected to an outer surface of the third torso motor seat, the fourth torso motor is disposed on the fourth torso motor seat, and an output shaft of the fourth torso motor is rotatably connected to the fourth torso motor seat; the thoracic cavity assembly is rotatably connected to the thigh assembly through the third torso motor and the fourth torso motor; when the third torso motor operates, the third torso motor is configured to drive the thoracic cavity assembly to rotate relative to the thigh assembly around the output shaft of the third torso motor; when the fourth torso motor operates within the plane formed by the first direction and the second direction, the fourth torso motor is configured to drive the thoracic cavity assembly to rotate relative to the thigh assembly around the output shaft of the fourth torso motor within a plane formed by the second direction and a third direction; the head structure is disposed at a middle portion of one end of the thoracic cavity assembly facing away from the thigh assembly; two opposite sides of the end of the thoracic cavity assembly facing away from the thigh assembly are provided with the robotic arms respectively, and the gripper structures are securely mounted at tail ends of the robotic arms respectively; and one end of the lower leg assembly facing away from the thigh assembly is securely connected to the chassis driving structure; and
wherein the first direction is a direction configured to be perpendicular to a ground, and the first direction, the second direction, and the third direction are perpendicular to one another.

2. The robot according to claim 1, wherein the lower leg assembly further comprises a first torso motor seat, a first torso bearing, a first torso bearing seat, a lower leg output connecting rod, a lower leg auxiliary connecting rod, a lower leg connecting support rod, a second torso motor seat, and lower leg housings, wherein one end of the first torso motor seat facing the robotic chassis structure is provided with a plurality of mounting lugs, each of the plurality of mounting lugs extends along a direction facing away from the first torso motor seat within the plane formed by the second direction and the third direction, and the first torso motor seat is securely connected to the robotic chassis structure through the plurality of mounting lugs using bolts; the first torso motor is mounted onto the first torso motor seat, the output shaft of the first torso motor extends along the third direction, and both the output shaft of the first torso motor and a motor tail cover of the first torso motor penetrate through the first torso motor seat to an outside of the first torso motor seat; the first torso bearing is disposed on the first torso motor seat through the first torso bearing seat and is located at one end of the motor tail cover of the first torso motor; the first torso motor seat and the first torso bearing seat are securely connected to the chassis driving structure; a first end of the lower leg output connecting rod is securely connected to the output shaft of the first torso motor, a first end of the lower leg auxiliary connecting rod is rotatably connected to the first torso motor seat through the first torso bearing, and a second end of the lower leg output connecting rod and a second end of the lower leg auxiliary connecting rod are securely connected to two ends of the second torso motor seat respectively; two ends of the lower leg connecting support rod along the third direction are securely connected to the lower leg output connecting rod and the lower leg auxiliary connecting rod respectively; and an outer surface of the lower leg output connecting rod and an outer surface of the lower leg auxiliary connecting rod are provided with the lower leg housings respectively;
the thigh assembly further comprises a second torso bearing, a thigh output connecting rod, a thigh auxiliary connecting rod, a thigh connecting support rod, and thigh housings, wherein the second torso motor is mounted onto the second torso motor seat, the output shaft of the second torso motor extends along the third direction, and both the output shaft of the second torso motor and a motor tail cover of the second torso motor penetrate through the second torso motor seat to an outside of the second torso motor seat; the second torso bearing is disposed within the second torso motor seat and is located at one end of the motor tail cover of the second torso motor; a first end of the thigh output connecting rod is securely connected to the output shaft of the second torso motor, a first end of the thigh auxiliary connecting rod is rotatably connected to the second torso motor seat through the second torso bearing, and a second end of the thigh output connecting rod and a second end of the thigh auxiliary connecting rod are rotatably connected to the thoracic cavity assembly; two ends of the thigh connecting support rod along the third direction are securely connected to the thigh output connecting rod and the thigh auxiliary connecting rod respectively; and an outer surface of the thigh output connecting rod and an outer surface of the thigh auxiliary connecting rod are provided with the thigh housings respectively; and
the thoracic cavity assembly further comprises a third torso bearing, a thoracic cavity bracket, a left arm mounting base, a right arm mounting base, a host mounting frame, a controller mounting frame, a head mounting base, and a thoracic cavity housing, wherein the third torso bearing is disposed within the third torso motor seat and is located at one end of a motor tail cover of the third torso motor, and one end of the thigh assembly facing the thoracic cavity assembly is rotatably connected to the third torso motor seat through the third torso bearing and the third torso motor; one end of the thoracic cavity bracket along the first direction is securely connected to a stator of the fourth torso motor; the head mounting base is disposed at the other end of the thoracic cavity bracket along the first direction and is configured for the head structure to be mounted onto; the left arm mounting base and the right arm mounting base are disposed at two ends of the thoracic cavity bracket along the third direction respectively and are both located at one end of the thoracic cavity bracket facing the head mounting base along the first direction, and the left arm mounting base and the right arm mounting base are securely connected to the robotic arms respectively; the host mounting frame and the controller mounting frame are both disposed at a middle portion of the thoracic cavity bracket along the first direction, the host mounting frame is configured for a personal computer (PC) host to be mounted onto, and the controller mounting frame is configured for a robotic controller to be mounted onto; the thoracic cavity housing is securely connected to the thoracic cavity bracket, and the fourth torso motor, the thoracic cavity bracket, the left arm mounting base, the right arm mounting base, the host mounting frame, the controller mounting frame, and the head mounting base are all disposed within the thoracic cavity housing.

3. The robot according to claim 1, wherein the head structure comprises a head middle housing, a head front housing, a head rear housing, a head skeleton assembly, a camera, and a neck housing; and
the head middle housing is a housing structure having openings at two ends of the head middle housing along the second direction, and a neck opening is provided on one side surface of the head middle housing along the first direction; the head front housing is mounted at one of opening ends of the head middle housing; the head rear housing is mounted at the other one of the opening ends of the head middle housing, and the head front housing, the head middle housing, and the head rear housing are assembled to form an enclosed chamber; the head skeleton assembly penetrates through the neck opening, one end of the head skeleton assembly is located within the chamber and is securely connected to an inner surface of the head middle housing, and the other end of the head skeleton assembly is located outside the chamber and is securely connected to the middle portion of the end of the thoracic cavity assembly facing away from the thigh assembly; the one end of the head skeleton assembly that is located within the chamber is provided with at least one camera, the head front housing is provided with a viewing port corresponding to each of the at least one camera, and a lens of each of the at least one camera is disposed within the viewing port; the neck housing is a tubular structure having openings at two ends of the neck housing along the first direction, one end of the neck housing is disposed at the neck opening, and the other end of the head skeleton assembly that is located outside the chamber is accommodated within the neck housing.

4. The robot according to claim 3, wherein the head skeleton assembly comprises a head support skeleton plate, a head connecting skeleton plate, and a connecting support member, wherein two ends of the connecting support member are connected to the head support skeleton plate and the head connecting skeleton plate respectively, and the connecting support member penetrates through the neck opening; the head support skeleton plate is located within the chamber and extends along the third direction, two ends of the head support skeleton plate along the third direction are securely connected to the inner surface of the head middle housing, and the at least one camera is disposed on one side surface of the head support skeleton plate facing the head front housing; the head connecting skeleton plate is located outside the chamber and is disposed parallel to the plane formed by the second direction and the third direction, and the head structure is securely connected to a torso of the robot through the head connecting skeleton plate.

5. The robot according to claim 1, wherein each robotic arm of the robotic arms comprises a robotic arm base, a robotic arm control board, a first joint mechanism, a second joint mechanism, a robotic upper arm structure, a third joint mechanism, a fourth joint mechanism, a robotic forearm structure, a fifth joint mechanism, and a sixth joint mechanism; and
the robotic arm control board is disposed within the robotic arm base, each robotic arm is securely connected to a torso of the robot through the robotic arm base, the robotic upper arm structure is connected to the robotic arm base through the second joint mechanism and the first joint mechanism, the robotic forearm structure is connected to the robotic upper arm structure through the fourth joint mechanism and the third joint mechanism, the fifth joint mechanism and the sixth joint mechanism are disposed at a tail end of the robotic forearm structure, and the robotic forearm structure is connected to a respective gripper structure of the gripper structures through the fifth joint mechanism and the sixth joint mechanism, wherein the first joint mechanism comprises a first arm motor, the second joint mechanism comprises a second arm motor, the first arm motor is securely mounted onto the robotic arm base, an output shaft of the first arm motor is securely connected to the second joint mechanism, and an output shaft of the second arm motor is securely connected to the robotic upper arm structure; the first arm motor is configured to drive a respective robotic arm to rotate around a central axis paralleled to a central axis of the robotic arm base when the first arm motor operates, the second arm motor is configured to drive the robotic upper arm structure to rotate around a central axis of the output shaft of the second arm motor when the second arm motor operates, and the central axis of the output shaft of the second arm motor is perpendicular to the central axis of the robotic arm base; the third joint mechanism comprises a third arm motor, the fourth joint mechanism comprises a fourth arm motor, the third arm motor is securely disposed at a tail end of the robotic upper arm structure, an output shaft of the third arm motor is securely connected to the fourth joint mechanism, and an output shaft of the fourth arm motor is securely connected to the robotic forearm structure; the third arm motor is configured to drive the robotic forearm structure to rotate around a central axis of the output shaft of the third arm motor when the third arm motor operates, wherein the central axis of the output shaft of the third arm motor is parallel to the central axis of the output shaft of the second arm motor, and the fourth arm motor is configured to drive the robotic forearm structure to rotate around a central axis of the output shaft of the fourth arm motor when the fourth arm motor operates, wherein the central axis of the output shaft of the fourth arm motor is perpendicular to the central axis of the output shaft of the third arm motor; the fifth joint mechanism comprises a fifth arm motor, the sixth joint mechanism comprises a sixth arm motor, the fifth arm motor is securely disposed at a tail end of the robotic forearm structure, an output shaft of the fifth arm motor is securely connected to the sixth joint mechanism, and an output shaft of the sixth arm motor is securely connected to the respective gripper structure; the fifth arm motor is configured to drive the respective gripper structure to rotate around a central axis of the output shaft of the fifth arm motor when the fifth arm motor operates, wherein the central axis of the output shaft of the fifth arm motor is perpendicular to the central axis of the output shaft of the fourth arm motor, and the sixth arm motor is configured to drive the respective gripper structure to rotate around a central axis of the output shaft of the sixth arm motor when the sixth arm motor operates, wherein the central axis of the output shaft of the sixth arm motor is perpendicular to the central axis of the output shaft of the fifth arm motor; the robotic arm control board is electrically connected to the first arm motor, the second arm motor, the third arm motor, the fourth arm motor, the fifth arm motor, and the sixth arm motor.

6. The robot according to claim 5, wherein the first joint mechanism further comprises a first arm bearing, a first arm bearing seat, a base housing, a first joint output member, and a second joint output member, wherein the base housing is securely mounted onto the robotic arm base, and the first arm motor and the robotic arm control board are disposed within the base housing; the first arm bearing is securely mounted onto the first arm motor through the first arm bearing seat; the first joint output member is securely mounted onto the output shaft of the first arm motor, a middle portion of the first joint output member is provided with a first joint connecting portion, each of two ends of the first joint connecting portion extends in a respective direction facing away from the first joint output member along a direction perpendicular to the first joint output member, and the first joint connecting portion is provided with a first joint mounting hole penetrating through two opposite end surfaces of the first joint connecting portion; the second joint output member is rotatably connected to an opening end of the base housing facing away from the robotic arm base through the first arm bearing, a middle portion of the second joint output member is provided with a second joint mounting hole penetrating through the second joint output member, the second joint mounting hole is disposed corresponding to the first joint mounting hole, and an end surface of the second joint output member that is located outside the base housing is securely connected to a second arm motor seat of the second arm motor; one end of the first joint connecting portion facing the first arm motor is inserted into the output shaft of the first arm motor, the other end of the first joint connecting portion facing away from the first arm motor is inserted into the middle portion of the second joint output member, and the second joint output member, the first joint output member, and the output shaft of the first arm motor are securely connected through a bolt that sequentially penetrates through the second joint mounting hole and the first joint mounting hole and is securely connected to the output shaft of the first arm motor;
the second joint mechanism further comprises a second arm bearing, the second arm motor seat, and a second arm bearing seat, wherein the second arm motor is disposed within the second arm motor seat, the second arm bearing is disposed within the second arm bearing seat, the second arm motor seat and the second arm bearing seat are engaged and secured, both the second arm motor seat and the second arm bearing seat are securely connected to the output shaft of the first arm motor, the output shaft of the second arm motor is securely connected to the robotic upper arm structure, and the robotic upper arm structure is rotatably connected to the second arm bearing seat through the second arm bearing;
the robotic upper arm structure comprises an upper arm connecting frame, an upper arm upper frame, an upper arm lower frame, and an upper arm housing, wherein the upper arm connecting frame comprises an upper arm output portion and an upper arm auxiliary portion; one end of the upper arm output portion is securely connected to the output shaft of the second arm motor, and one end of the upper arm auxiliary portion is rotatably connected to the second arm bearing seat through the second arm bearing; the other end of the upper arm output portion and the other end of the upper arm auxiliary portion are provided with upper arm mounting plates respectively, and each upper arm mounting plate of the upper arm mounting plates is a rectangular plate structure; the upper arm upper frame and the upper arm lower frame are engaged, are securely connected by bolts, and are symmetrically disposed, two opposite side surfaces of the upper arm upper frame and two opposite side surfaces of the upper arm lower frame are formed with upper arm mounting grooves respectively, each upper arm mounting plate is snap-fitted with respective two upper arm mounting grooves on a same side of the upper arm upper frame and the upper arm lower frame, each upper arm mounting plate is securely connected to the upper arm upper frame and the upper arm lower frame by bolts so that the upper arm connecting frame, the upper arm upper frame, and the upper arm lower frame are securely connected, and one end of the upper arm upper frame facing away from the upper arm connecting frame and one end of the upper arm lower frame facing away from the upper arm connecting frame are securely connected to the third joint mechanism; the upper arm housing comprises an upper arm upper housing and an upper arm lower housing, the upper arm lower housing is securely connected to the upper arm lower frame by bolts, the upper arm upper housing is securely connected to the upper arm connecting frame by bolts, and the upper arm upper housing and the upper arm lower housing are engaged so that the upper arm connecting frame, the upper arm upper frame, and the upper arm lower frame are located within the upper arm housing;
the third joint mechanism further comprises a third arm motor seat, a third arm bearing, a third arm bearing seat, and a first joint connecting frame, wherein the third arm motor is securely mounted within the third arm motor seat, the third arm bearing is mounted within the third arm bearing seat, and the third arm bearing seat and the third arm motor seat are engaged and securely connected; the first joint connecting frame comprises a first joint output portion, a first joint auxiliary portion, and a second joint connecting portion, the fourth joint mechanism is disposed on one end surface of the second joint connecting portion, one end of the first joint output portion and one end of the first joint auxiliary portion are securely connected to two opposite side surfaces of the second joint connecting portion by bolts respectively, the other end of the first joint output portion is securely connected to the output shaft of the third arm motor, and the other end of the first joint auxiliary portion is rotatably connected to the third arm bearing seat through the third arm bearing;
the fourth joint mechanism further comprises a fourth arm motor seat, a fourth arm bearing, a fifth arm bearing, a fourth arm bearing seat, and a joint output shaft, wherein the fourth arm motor is securely mounted within the fourth arm motor seat, both the fourth arm bearing and the fifth arm bearing are mounted within the fourth arm bearing seat, the fourth arm bearing seat and the fourth arm motor seat are engaged and securely connected, one end of the joint output shaft is securely connected to the output shaft of the fourth arm motor, and the other end of the joint output shaft is securely connected to the robotic forearm structure through the fourth arm bearing and the fifth arm bearing;
the robotic forearm structure comprises a first forearm connecting rod, a second forearm connecting rod, a third forearm connecting rod, a forearm housing bracket, and a forearm housing, wherein two ends of the second forearm connecting rod are securely connected to one end of the first forearm connecting rod and one end of the third forearm connecting rod respectively, the other end of the first forearm connecting rod is securely connected to the other end of the joint output shaft, and the other end of the third forearm connecting rod is securely connected to a fifth arm motor seat of the fifth arm motor; one end of the forearm housing bracket is securely connected to an end surface of the fourth arm bearing seat, the forearm housing is securely connected to the forearm housing bracket, and the forearm housing bracket is securely connected to the fourth arm bearing seat, and the first forearm connecting rod, the second forearm connecting rod, the third forearm connecting rod, and the forearm housing bracket are all located within the forearm housing;
the forearm housing comprises a forearm upper housing, a forearm lower housing, and a forearm snap-fit housing, wherein the forearm lower housing is securely connected to the forearm housing bracket by bolts, two opposite ends of an inner surface of the forearm lower housing facing the fifth arm motor are formed with two forearm snap-fit slots respectively, the forearm snap-fit housing is provided with two forearm snap-fit blocks, the two forearm snap-fit blocks are in one-to-one correspondence with the two forearm snap-fit slots, the two forearm snap-fit blocks are securely snap-fitted within the two forearm snap-fit slots respectively, and the forearm snap-fit housing is securely connected to one end of the forearm lower housing to form a circular through hole for a connection of the robotic forearm structure and the fifth joint mechanism; one end of the forearm upper housing facing the fourth arm motor seat is provided with two forearm connecting snap-fit portions, an outer surface of the first joint output portion and an outer surface of the first joint auxiliary portion are provided with joint housings respectively, each of the joint housings is formed with a circular snap-fit slot in a circumferential direction of each of the joint housings, each of the two forearm connecting snap-fit portions is snap-fitted with the circular snap-fit slot, the forearm upper housing and the forearm snap-fit housing are snap-fitted and secured, and the forearm upper housing and the forearm lower housing are securely connected by bolts so that the forearm upper housing, the forearm lower housing, and the forearm snap-fit housing jointly form an enclosed forearm inner chamber; the first forearm connecting rod, the second forearm connecting rod, the third forearm connecting rod, the forearm housing bracket, the fourth arm bearing, the fifth arm bearing, the fourth arm bearing seat, and the joint output shaft are all located within the forearm inner chamber;
the fifth joint mechanism further comprises the fifth arm motor seat, an arm output frame, an arm wire-pressing buckle, and an arm wire-pressing housing, wherein the fifth arm motor is securely mounted within the fifth arm motor seat; the arm output frame is an L-shaped bracket structure, one end of a vertical portion of the arm output frame facing away from a horizontal portion of the arm output frame is securely connected to the output shaft of the fifth arm motor, and a sixth arm motor seat of the sixth arm motor is securely disposed on the horizontal portion of the arm output frame; the arm wire-pressing buckle is disposed on a motor tail cover of the fifth arm motor seat, and a wire of the sixth arm motor is pressed and limited by the arm wire-pressing buckle, penetrates through the arm wire-pressing buckle, and enters the forearm housing of the robotic forearm structure; the arm wire-pressing housing is securely connected to the motor tail cover of the fifth arm motor seat to cover the arm wire-pressing buckle; and
the sixth joint mechanism further comprises the sixth arm motor seat and a gripper securing seat, wherein the sixth arm motor is securely mounted within the sixth arm motor seat; the sixth arm motor seat is disposed on an end surface of the horizontal portion of the arm output frame facing the fifth arm motor seat, the output shaft of the sixth arm motor penetrates through the horizontal portion of the arm output frame and is securely connected to the gripper securing seat, and the respecitve gripper structure is securely mounted onto the gripper securing seat.

7. The robot according to claim 1, wherein each gripper structure of the gripper structures comprises a gripper mounting seat, a gripper driving motor, a rotary-to-linear mechanism, and two fingers, wherein each gripper structure is securely mounted onto a respective robotic arm through the gripper mounting seat; a motor tail cover end of the gripper driving motor is securely mounted onto the gripper mounting seat; the rotary-to-linear mechanism is securely connected to an output shaft of the gripper driving motor, the two fingers are connected to the rotary-to-linear mechanism, the rotary-to-linear mechanism is configured to convert a rotary motion of the output shaft of the gripper driving motor into linear motions of the two fingers, and when the gripper driving motor operates, the gripper driving motor is configured to drive the two fingers to move away from each other to open or move toward each other to close through the rotary-to-linear mechanism so that each gripper structure performs gripping and releasing through the two fingers.

8. The robot according to claim 7, wherein the rotary-to-linear mechanism comprises a grooved wheel, two pulley pins, a linear structure, two linear sliders, and two finger mounting members; and
the grooved wheel is securely connected to the output shaft of the gripper driving motor, and two rotary sliding grooves are symmetrically formed on the grooved wheel; the two pulley pins are disposed within the two rotary sliding grooves respectively; the linear structure is securely connected to a motor housing of the gripper driving motor, and two linear sliding grooves are symmetrically formed on the linear structure; the two linear sliders are disposed within the two linear sliding grooves respectively; the grooved wheel is located within a chamber between the linear structure and the gripper driving motor, and the two pulley pins are securely connected to end surfaces of the two linear sliders respectively; the other end surfaces of the two linear sliders are securely connected to the two fingers through the two finger mounting members respectively; when the gripper driving motor operates, the output shaft of the gripper driving motor is configured to drive the grooved wheel to rotate to drive the two pulley pins to slide within the two rotary sliding grooves respectively and to drive the two linear sliders to perform linear motions along the two linear sliding grooves respectively so that the two linear sliders move toward or away from each other, and the two fingers move away from each other to open or move toward each other to close through the two finger mounting members.

9. The robot according to claim 1, wherein the chassis driving structure comprises a chassis middle housing, a chassis upper housing, a chassis middle front housing, a chassis middle rear housing, a chassis lower housing, a chassis skeleton assembly, a front left steering wheel assembly, a front right steering wheel assembly, and a rear steering wheel assembly; and
the chassis middle housing is a housing structure that has two opening ends along the first direction and has a wide end and a narrow end along the second direction, wherein the narrow end is narrower than the wide end, and the wide end is provided with an opening along the second direction; the chassis upper housing is mounted at one of opening ends of the chassis middle housing, a middle portion of the chassis upper housing is provided with a notch along the second direction, and an opening end of the notch faces the wide end; one end of the chassis middle front housing along the first direction is mounted at the opening end of the notch, and one end of the chassis middle front housing along the second direction is mounted at an opening end of the wide end; one end of the chassis middle rear housing along the second direction is mounted at a non-opening end of the notch; the chassis lower housing is mounted at the other one of the opening ends of the chassis middle housing, and the chassis middle housing, the chassis upper housing, the chassis middle front housing, the chassis middle rear housing, and the chassis lower housing are assembled to form an enclosed chamber; one side surface of the chassis skeleton assembly facing the chassis upper housing along the first direction is provided with a rectangular protrusion, one end of the rectangular protrusion along the second direction abuts against and is secured to the other end of the chassis middle front housing along the second direction, and the other end of the rectangular protrusion along the second direction abuts against and is secured to the other end of the chassis middle rear housing along the second direction; all portions of the chassis skeleton assembly other than the rectangular protrusion are disposed within the chamber, and the chassis middle housing, the chassis middle front housing, the chassis middle rear housing, and the chassis lower housing are all mounted onto the chassis skeleton assembly; one end of the front left steering wheel assembly is located within the chamber and is securely connected to one end of the chassis skeleton assembly along the third direction, and the other end of the front left steering wheel assembly is located outside the chamber; one end of the front right steering wheel assembly is located within the chamber and is securely connected to the other end of the chassis skeleton assembly along the third direction, and the other end of the front right steering wheel assembly is located outside the chamber; one end of the rear steering wheel assembly is located within the chamber and securely connected to one end of the chassis skeleton assembly facing away from the wide end along the second direction, and the other end of the rear steering wheel assembly is located outside the chamber; the front left steering wheel assembly, the front right steering wheel assembly, and the rear steering wheel assembly are located at three vertices of a triangle.

10. The robot according to claim 9, wherein the chassis skeleton assembly comprises a chassis skeleton upper panel, a chassis skeleton middle panel, a chassis skeleton lower panel, a left middle-panel support frame, a right middle-panel support frame, a panel rear support plate, a panel left support plate, and a panel right support plate, wherein the chassis skeleton upper panel, the chassis skeleton middle panel, and the chassis skeleton lower panel are sequentially disposed along the first direction; the panel rear support plate extends along the first direction and is located adjacent to the rear steering wheel assembly, and two ends of the panel rear support plate along the first direction are connected to the chassis skeleton upper panel and the chassis skeleton lower panel respectively; the panel left support plate extends along the first direction and is located adjacent to the front left steering wheel assembly, and two ends of the panel left support plate along the first direction are connected to the chassis skeleton upper panel and the chassis skeleton lower panel respectively; the panel right support plate extends along the first direction and is located adjacent to the front right steering wheel assembly, and two ends of the panel right support plate along the first direction are connected to the chassis skeleton upper panel and the chassis skeleton lower panel respectively; the chassis skeleton middle panel comprises a front left steering wheel assembly mounting plate, a front right steering wheel assembly mounting plate, and a rear steering wheel assembly mounting plate; one end of the left middle-panel support frame is securely mounted onto one side surface of the chassis skeleton upper panel facing the front left steering wheel assembly, and the other end of the left middle-panel support frame is securely mounted onto the front left steering wheel assembly mounting plate; one end of the right middle-panel support frame is securely mounted onto one side surface of the chassis skeleton upper panel facing the front right steering wheel assembly, and the other end of the right middle-panel support frame is securely mounted onto the front right steering wheel assembly mounting plate; one end of the rear steering wheel assembly mounting plate facing the rear steering wheel assembly along the second direction is securely mounted onto the panel rear support plate, and two ends of the rear steering wheel assembly mounting plate along the third direction are connected to the front left steering wheel assembly and the front right steering wheel assembly respectively; the front left steering wheel assembly, the front right steering wheel assembly, and the rear steering wheel assembly each comprise a limiting block, a steering motor, a steering motor support plate, a hub motor support plate and a hub motor assembly, the steering motor, the steering motor support plate, the hub motor support plate, and the hub motor assembly are sequentially disposed along the first direction; an end portion of one side of the steering motor support plate along the second direction is mounted onto a stator of the steering motor, and an end portion of the other side of the steering motor support plate along the second direction is mounted onto a corresponding panel support plate; the hub motor support plate is mounted onto a rotor of the steering motor; the hub motor assembly is mounted onto the hub motor support plate, and the limiting block is mounted at an end portion of the hub motor support plate facing the stator along the second direction; and the steering motor support plate is configured to restrict a rotary range of the limiting block.
